(19) United States
(12) Patent Application Publication
(10) Pub. No.: US 2024/0308215 A1
(43) Pub. Date: Sep. 19, 2024

(54) LIQUID DISCHARGE HEAD AND LIQUID DISCHARGE APPARATUS

(71) Applicant: Yuzuru Kuramochi, KANAGAWA (JP)

(72) Inventor: Yuzuru Kuramochi, KANAGAWA (JP)

(21) Appl. No.: 18/604,550

(22) Filed: Mar. 14, 2024

(30) Foreign Application Priority Data
Mar. 17, 2023 (JP) 2023-042493

(51) Int. Cl. B41J 2/14

(52) U.S. Cl. CPC B41J 2/14201; B41J 2/1433

(57) ABSTRACT

A liquid discharge head includes a nozzle plate, a needle valve, a mover, a housing, and a sealing member. The needle valve includes a first part having a diameter and a second part having a diameter smaller than the first part. The second part has a leading end contactable with a nozzle to close the nozzle. The needle valve is movable between a position to open the nozzle and a position to close the nozzle. The mover moves the needle valve. The housing has a side wall, a bottom wall, and a liquid chamber communicating with the nozzle. The side wall and the bottom wall define a container containing the mover. The sealing member is disposed between the first part of the needle valve and the bottom wall to seal the container from the liquid chamber. The sealing member is deformable in accordance with the movement of the needle valve.

### CROSS-REFERENCE TO RELATED APPLICATIONS

This patent application is based on and claims priority pursuant to 35 U.S.C. § 119(a) to Japanese Patent Application No. 2023-042493, filed on Mar. 17, 2023, in the Japan Patent Office, the entire disclosure of which is hereby incorporated by reference herein.

### BACKGROUND

### Technical Field

Embodiments of the present disclosure relate to a liquid discharge head and a liquid discharge apparatus.

### Related Art

A liquid discharge head is known that discharges liquid droplets such as ink from nozzles. Such a liquid discharge head includes on-off valves such as needle valves disposed on the respective nozzles, nozzle opening-closing drivers, such as actuators or piezoelectric elements, to cause the respective on-off valves to contact and separate from the respective nozzles, and a controller. The liquid discharge head causes the controller to control the nozzle opening-closing drivers to open and close the respective nozzle to discharge the liquid droplets.

Such a liquid discharge head supplies liquid to be discharged to the nozzles under pressure. In this condition, the liquid discharge head causes the nozzle on-off valves to contact or separate from the respective nozzles. By so doing, the liquid that is supplied under pressure is discharged from the nozzle as liquid droplets only while the nozzle on-off valve is separated from the nozzle.

A sealing member is disposed between a liquid chamber filled with the ink and the nozzle opening-closing driver to prevent the ink from flowing into the nozzle opening-closing driver such as a piezoelectric element, while the ink is discharged.

It is known that an O-ring as a sealing member is disposed between the needle valve and the liquid chamber and is compressed in the radial direction to prevent the ink from flowing into the nozzle opening-closing driver.

For example, a liquid discharge head has been disclosed that presses a valve formed to be movable toward a discharge port for discharging ink to control discharge of ink. In such a liquid discharge head, a recess is disposed at a position at which the valve faces the discharge port. In addition, the liquid discharge head includes a sealing member fitted onto the valve to prevent ink from flowing into the actuator.

In such a liquid discharge head, the sealing member slides on the needle valve or an inner wall of the housing of the liquid discharge head to move the needle valve to discharge ink.

### SUMMARY

In an embodiment of the present disclosure, a liquid discharge head includes a nozzle plate, a needle valve, a mover, a housing, and a sealing member. The nozzle plate has a nozzle from which a liquid is dischargeable in a discharge direction. The needle valve includes a first part having a first diameter and a second part having a second diameter smaller than the first part. The second part has a leading end contactable with the nozzle to close the nozzle. The needle valve is movable in the discharge direction between a separation position at which the needle valve is separated from the nozzle to open the nozzle and a contact position at which the leading end of the second part of the needle valve contacts the nozzle to close the nozzle. The mover moves the needle valve in the discharge direction. The housing has a side wall extending in the discharge direction, a bottom wall perpendicular to the side wall, and a liquid chamber communicating with the nozzle. The side wall and the bottom wall define a container containing the mover inside the housing. The sealing member is disposed between the first part of the needle valve and the bottom wall of the housing in the discharge direction to seal the container from the liquid chamber. The sealing member is deformable in the discharge direction in accordance with the movement of the needle valve.

In another embodiment of the present disclosure, a liquid discharge head includes a nozzle plate, a needle valve, a mover, a housing, and a sealing member. The nozzle plate has a nozzle from which a liquid is dischargeable in a discharge direction. The needle valve includes a first part having a first diameter and a second part having a second diameter smaller than the first part. The second part extends in a direction perpendicular to the discharge direction and has a leading end contactable with the nozzle to close the nozzle. The needle valve is movable in the discharge direction between a separation position at which the needle valve is separated from the nozzle to open the nozzle and a contact position at which the leading end of the second part of the needle valve contacts the nozzle to close the nozzle. The mover moves the needle valve in the discharge direction. The housing has a container containing the mover inside the housing and a liquid chamber communicating with the nozzle. The liquid chamber has a liquid chamber wall face extending perpendicular to the discharge direction. The sealing member is disposed between the first part of the needle valve and the liquid chamber wall face to seal the container from the liquid chamber. The sealing member is deformable in the discharge direction in accordance with the movement of the needle valve.

In still another embodiment of the present disclosure, a liquid discharge head includes a nozzle plate, a needle valve, a mover, a housing, and a sealing member. The nozzle plate has a nozzle from which a liquid is dischargeable in a discharge direction. The needle valve includes a first part having a first diameter and a second part having a second diameter smaller than the first part. The second part has a leading end contactable with the nozzle to close the nozzle. The needle valve is movable in the discharge direction between a separation position at which the needle valve is separated from the nozzle to open the nozzle and a contact position at which the leading end of the second part of the needle valve contacts the nozzle to close the nozzle. The mover moves the needle valve in the discharge direction. The housing has a side wall extending in the discharge direction a liquid chamber communicating with the nozzle. The sealing member is disposed between the first part of the needle valve and a bottom wall of the housing in the discharge direction to seal a container from the liquid chamber. The sealing member is deformable in the discharge direction in accordance with the movement of the needle valve. The needle valve includes a first holding portion extending in a direction perpendicular to the discharge direction to hold the sealing member. A portion of the bottom wall defines a second holding portion extending in the direction perpendicular to the discharge direction to hold the sealing member. The first holding portion and the second holding portion are positioned to partially overlap each other when viewed from the discharge direction.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIGS. 1A and 1B are external views of a liquid discharge head according to an embodiment of the present disclosure;

FIG. 2 is an overall cross-sectional view of the liquid discharge head of FIG. 1A, cut along a cross section A-A in FIG. 1A.

FIG. 3 is a cross-sectional view of a lower portion of the liquid discharge head of FIG. 2, indicating relative positions of a heater and the liquid discharge head;

FIG. 4 is a cross-sectional view of a liquid discharge module according to a comparative example of the embodiments of the present disclosure;

FIG. 5 is a diagram illustrating a disadvantage of the liquid discharge module of the comparative example;

FIG. 6 is a diagram illustrating a liquid discharge module according to a first embodiment of the present disclosure;

FIG. 7A is a diagram illustrating a liquid discharge module, indicating how a sealing member operates when a nozzle is closed, according to an embodiment of the present disclosure;

FIG. 7B is a diagram illustrating the liquid discharge module of FIG. 7A, indicating how the sealing member operates when the nozzle is opened;

FIG. 8 is a diagram illustrating a liquid discharge module according to a second embodiment of the present disclosure;

FIG. 9A is a diagram illustrating a liquid discharge module according to a third embodiment of the present disclosure;

FIG. 9B is a diagram illustrating a liquid discharge module according to a fourth embodiment of the present disclosure;

FIG. 10 is a diagram illustrating a liquid discharge module according to a fifth embodiment of the present disclosure;

FIG. 11A is a diagram illustrating a liquid discharge module according to a sixth embodiment of the present disclosure;

FIG. 11B is a diagram illustrating a liquid discharge module according to a seventh embodiment of the present disclosure;

FIGS. 12A and 12B are diagrams each illustrating an overall schematic configuration of a liquid discharge apparatus, according to an embodiment of the present disclosure;

FIG. 13 is a schematic diagram illustrating a configuration of another liquid discharge apparatus of the present disclosure;

FIG. 14 is a perspective view of a liquid discharge apparatus mounted on an upper portion of an automobile, according to an embodiment of the present disclosure;

FIG. 15 is a perspective view of the liquid discharge apparatus of FIG. 18 mounted on a lateral side of an automobile;

FIGS. 16A, 16B, and 16C are diagrams each illustrating a case in which a liquid discharge apparatus discharges liquid onto a spherical surface, according to an embodiment of the present disclosure;

FIG. 17 is a schematic diagram illustrating an electrode manufacturing apparatus to manufacture electrodes in an electrode manufacturing method, according to an embodiment of the present disclosure; and

FIG. 18 is a schematic diagram illustrating an electrode manufacturing apparatus to manufacture electrodes in a manufacturing method of an electrode mixture layer, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings.

In the drawings for illustrating embodiments of the present disclosure, like reference numerals are assigned to elements such as members and parts that have a like function or a like shape as long as differentiation is possible, and descriptions of such elements may be omitted once the description is provided.

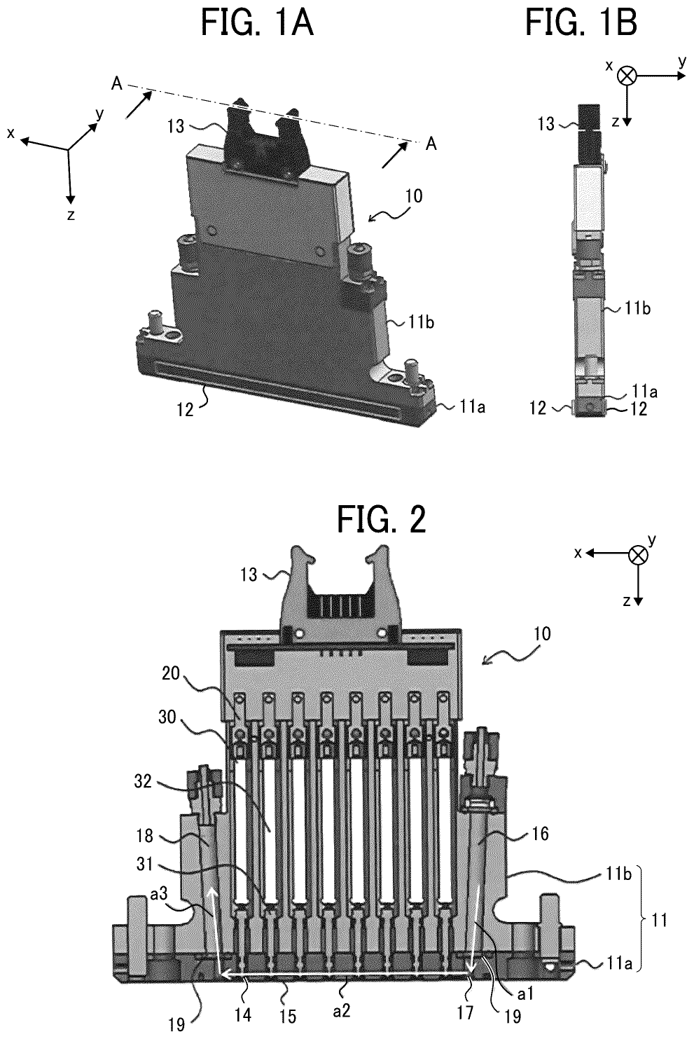

FIGS. 1A and 1B are external views of a liquid discharge head 10 according to an embodiment of the present disclosure. FIG. 1A is an overall perspective view of the liquid discharge head 10. FIG. 1B is an overall side view of the liquid discharge head 10. The liquid discharge head 10 according to the present embodiment discharges ink as liquid. First, the liquid discharge head 10 of the present embodiment is described with reference to FIGS. 1A and 1B. In the present embodiment, a width direction of the liquid discharge head 10, i.e., a direction in which nozzles of the liquid discharge head 10 are arranged in FIG. 1A, or a direction perpendicular to the sheet surface in FIG. 1B, is x direction. A depth direction of the liquid discharge head 10 in FIG. 1A, i.e., a lateral direction in FIG. 1B is y direction. A height direction of the liquid discharge head 10 in FIG. 1A, i.e., a vertical direction in FIG. 1B, is z direction, which is a direction in which on-off valves open and close, which may also be referred to simply as needle valves, to be described below, a longitudinal direction in which the on-off valves are driven to move, and the vertical direction in FIG. 2. The above-described definitions of the x direction, the y direction, and the z direction are similar in the following drawings unless otherwise specified.

The liquid discharge head 10 that serves as a liquid discharge head according to the present embodiment includes a first housing 11a and a second housing 11b. The second housing 11b is stacked on and bonded to the first housing 11a. The first housing 11a is formed of a material having high thermal conductivity, such as metal. The second housing 11b is formed of a material similar to the material of which the first housing 11a is formed. In the following description, the first housing 11a and the second housing 11b are collectively referred to as a housing 11 unless distinguished.

The first housing 11a includes heaters 12 as heaters on the front side and the rear side of the first housing 11a. The temperature at which the heaters 12 heat the first housing 11a, is controllable. The second housing 11b includes a connector 13 in an upper portion of the second housing 11b to communicate electric signals.

FIG. 2 is an overall cross-sectional view of the liquid discharge head 10, cut along a cross section A-A in FIG. 1A. The first housing 11a holds a nozzle plate 15 as a nozzle plate, which serves as a member to form discharge ports. The nozzle plate 15 includes nozzles 14, which serve as discharge ports to discharge liquid. The first housing 11a, as a portion of the housing of liquid discharge head 10, includes a channel 17, which serves as a liquid supply channel. The channel 17 may also be referred to simply as a liquid chamber in the following description. The channel 17 sends ink supplied from a supply port 16 to a collection port 18 via an upper surface of the nozzle plate 15.

The second housing 11b includes the supply port 16 and the collection port 18. The supply port 16 and the collection port 18 are connected to one side and the other side of the channel 17, respectively. Multiple liquid discharge modules 30 are disposed between the supply port 16 and the collection port 18. The liquid discharge modules 30 discharge ink in the channel 17 from the respective nozzles 14. In addition, a restricting member 20 is disposed on the upper portion of each of the liquid discharge modules 30.

The number of the liquid discharge modules 30 correspond to the number of the nozzles 14 disposed in the first housing 11a. In the present embodiment, eight of the liquid discharge modules 30 that correspond to eight of the nozzles 14 arranged in a row are disposed. The number and arrangement of the nozzles 14 and the liquid discharge modules are not limited to the above-described number and arrangement. For example, the number of the nozzles 14 and the number of the liquid discharge modules 30 may be one instead of multiple. The nozzles 14 and the liquid discharge modules 30 may be arranged in multiple rows instead of one row.

In FIG. 2, housing seals 19 that serve as housing sealing members, are disposed at joints between the first housing 11a and the second housing 11b. In the present embodiment, an O-ring is employed as the housing seal 19, and the housing seal 19 as the O-ring prevents ink from leaking from the joint between the first housing 11a and the second housing 11b. Such a configuration as described above allows the supply port 16 to take in pressurized ink from outside, send the ink in a direction indicated by arrow a1, and supply the ink to the channel 17. The channel 17 sends the ink supplied from the supply port 16 in a direction indicated by arrow a2. The collection port 18 collects the ink, which has not been discharged from the nozzles 14 arranged along the channel 17, in a direction indicated by arrow a3.

The liquid discharge module 30 includes an on-off valve 31, which serves as a needle valve, and a piezoelectric element 32, which serves as a moving member, as a driving unit. The on-off valves 31 open and close the respective nozzles 14. The piezoelectric elements 32 drive the respective on-off valves 31. The piezoelectric element 32 expands and contracts in a longitudinal direction of the piezoelectric element 32, which is the vertical direction, i.e., the z direction in FIG. 2, when a voltage is applied to the piezoelectric element 32. The piezoelectric element 32 is controlled by a controller.

In the above-described configuration of the liquid discharge head 10, when the piezoelectric element 32 is operated to move the on-off valve 31 upward, the nozzle 14 that has been closed by the on-off valve 31 is opened. Accordingly, ink can be discharged from the nozzle 14. When the piezoelectric element 32 is operated to move the on-off valve 31 downward, a tip end of the on-off valve 31 seals the nozzle 14 to close the nozzle 14. Accordingly, ink is not discharged from the nozzle 14. In the following description, the opening of the nozzle 14 may be referred to as opening of the nozzle, and the closing of the nozzle 14 may be referred to as closing of the nozzle.

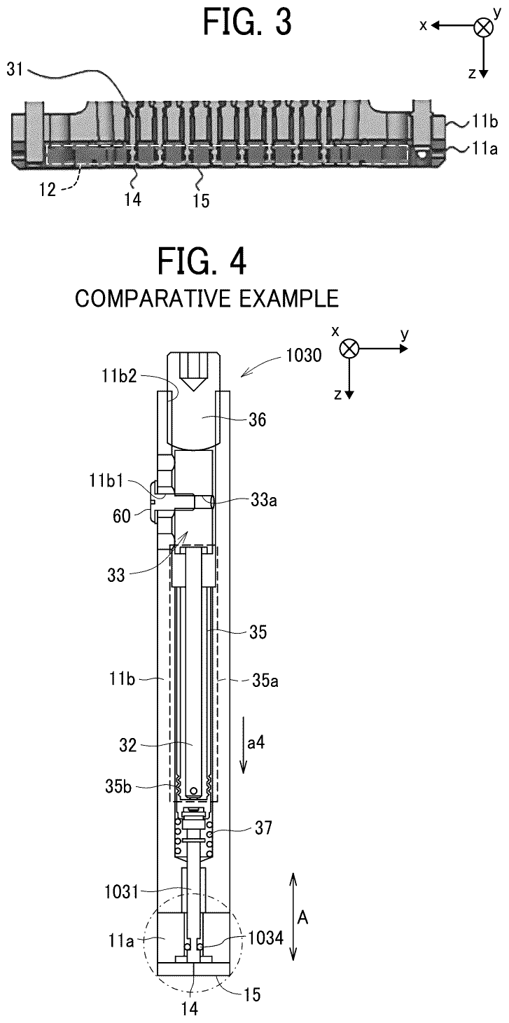

FIG. 3 is a cross-sectional view of a lower portion of the liquid discharge head 10, indicating relative positions of the heater 12 and the liquid discharge head 10, according to an embodiment of the disclosure. The first housing 11a includes the heaters 12. As indicated by a broken line in FIG. 3, each of the heaters 12 is disposed in the vicinity of the nozzles 14 such that the each of the heaters 12 crosses the multiple nozzles 14.

### COMPARATIVE EXAMPLE

Next, a liquid discharge module according to a comparative example is described in detail below. Before describing the detail of the liquid discharge module 30 according to embodiments of the present disclosure, the liquid discharge module according to the comparative example to be compared with the liquid discharge module 30 is described. Subsequently, the disadvantage of the liquid discharge module according to the comparative example is described. Subsequently, circumstances that led to embodiments of the present disclosure is described below.

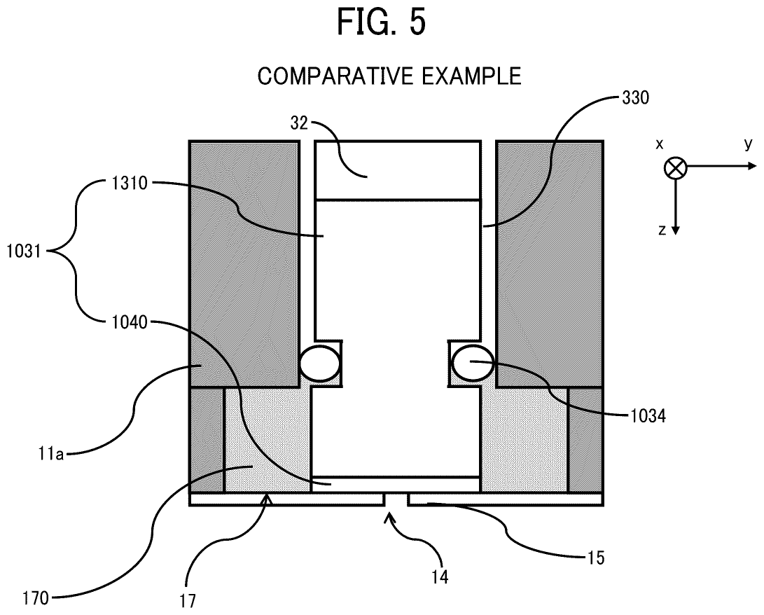

FIG. 4 is a cross-sectional view of a liquid discharge module 1030 according to the comparative example of the above embodiments of the present disclosure. FIG. 4 is a cross-sectional view of the single liquid discharge module 1030. FIG. 5 is a diagram illustrating a disadvantage of the liquid discharge module 1030 of the comparative example. FIG. 5 is an enlarged diagram illustrating a relevant portion of the liquid discharge module 1030 of FIG. 4. More specifically, FIG. 5 is an enlarged diagram illustrating a portion surrounded by a circle of a dashed line in FIG. 4, which is a portion in the vicinity of the nozzle 14 of the liquid discharge module 1030. An O-ring 1034 is mounted on the outer perimeter of the shaft of an on-off valve 1031. The O-ring 1034 serves as a sealing member to prevent high pressure ink from leaking.

The liquid discharge module 1030 typically includes, for example, the on-off valve 1031, the piezoelectric element 32 described above, a fixing member 33, a holder 35, and a plug 36.

The holder 35 includes a driver container 35a inside the holder 35. The holder 35 contains and holds the piezoelectric element 32 in the driver container 35a. The holder 35 is made of metal that is elastically expandable and contractible in the longitudinal direction of the piezoelectric element 32. As a metal that is elastically expandable and contractible, stainless steel such as SUS304 or SUS316L can be employed. The holder 35 is a frame in which multiple elongated members extending in the longitudinal direction of the piezoelectric element 32 are arranged around the piezoelectric element 32. For example, four elongated members are arranged at intervals of 90°. The piezoelectric element 32 is inserted into the holder 35 inside the elongated members of the holder 35.

The longitudinal direction of the piezoelectric element 32 is a direction indicated by a double-headed arrow A illustrated in FIG. 4. The direction indicated by the double-headed arrow A is also the longitudinal direction of the on-off valve 1031, the liquid discharge module 1030, and the second housing 11b. The direction indicated by the double-headed arrow A is a direction in which the on-off valve 1031 moves, a height direction of the liquid discharge head 10 in FIGS. 1A and 1B, i.e., the z direction, and the vertical direction in FIG. 2.

The on-off valve 1031 is coupled to a tip end of the holder 35 closer to the nozzle 14. A bellows portion 35b is formed in a portion of the holder 35 closer to the nozzle 14. The bellows portion 35b causes the tip end of the holder 35 to expand and contract in the longitudinal direction of the piezoelectric element 32 in a similar manner to the piezoelectric element 32 when the piezoelectric element 32 expands and contracts.

The fixing member 33 is coupled to a base end of the holder 35, which is opposite to the tip end of the holder 35 closer to the nozzle 14. In other words, the fixing member 33 is contained in an upper end of the second housing 11b.

The fixing member 33 includes a through-screw hole 33a extending in the radial direction of the fixing member 33. A positioning screw 60 is screwed into the through-screw hole 33a from the outside of the second housing 11b.

The positioning screw 60 is inserted into a long hole 11b1 formed in the upper end of the second housing 11b in the longitudinal direction. Accordingly, the positioning screw 60 is movable in the longitudinal direction of the second housing 11b by a predetermined distance. The positioning screw 60 is tightened with the fixing member 33 being positioned in the longitudinal direction.

As illustrated in FIG. 4, a female screw hole 11b2 is formed in an upper-end opening of the second housing 11b. A plug 36 that contacts the restricting member 20 illustrated in FIG. 2 is screwed into the female screw hole 11b2. The plug 36 contacts an upper end of the fixing member 33 positioned in the longitudinal direction by the positioning screw 60 to finally fix the position of the fixing member 33.

A compression spring 37 is disposed in a lower end of the second housing 11b. For example, the piezoelectric element 32, the holder 35 that holds the piezoelectric element 32 are biased upward by the compression spring 37.

As illustrated in FIG. 5, the on-off valve 1031 includes a shaft-shaped needle 1310. A valve 1040 that is formed of an elastic material such as rubber is attached to a tip end of the needle 1310 closer to the nozzle 14. The shaft-shaped needle 1310 is formed of metal such as stainless steel.

The driving unit includes the piezoelectric element 32 to serve as a driving member to cause the on-off valve 1031 to reciprocate. The needle 1310 of the on-off valve 1031 is coupled to the piezoelectric element 32 and interlocks the driving movement of the needle 1310 with the valve 1040.

When the piezoelectric element 32 is operated to move the valve 1040 attached to the tip end of the needle 1310, downward toward the nozzle 14 in FIG. 4, the valve 1040 attached to the tip end of the needle 1310 of the on-off valve 1031 is pressed against the nozzle plate 15. Accordingly, the valve 1040 seals the nozzle 14. By contrast, when the on-off valve 1031 is moved upward in FIG. 4, the valve 1040 is separated from the nozzle plate 15. Accordingly, the nozzle 14 is opened. As described above, the on-off valve 1031 moves between a position at which the valve 1040 is pressed against and contacts the nozzle plate 15 and a position at which the on-off valve 1031 is separated from the nozzle plate 15. By so doing, the nozzle 14, i.e., the discharge port, is opened and closed.

A description is given below of the configuration of the liquid discharge module according to the comparative example is described with reference to FIG. 5. The O-ring 1034 serves as a sealing member to seal ink such that the ink 170 does not enter a piezoelectric element container 330 in which the piezoelectric element 32 is contained. The O-ring 1034 is compressed in the radial direction of the O-ring 1034. The O-ring 1034 contacts the first housing 11a when the O-ring 1034 is compressed. By so doing, the O-ring 1034 slides on the first housing 11a by the movement of the on-off valve 1031 to generate sliding resistance. Accordingly, the slidability of the O-ring 1034 with the first housing 11a is reduced. In addition, the liquid discharge module 1030 is small in size and is difficult to assemble. For this reason, the assembly of the liquid discharge module 1030 may not be performed as designed, and the axial misalignment of the needle 1310 of the on-off valve 1031, the inclination or the twist of the O-ring 1034 when the O-ring 1034 is mounted, may occur.

Accordingly, the slidability of the O-ring 1034 with the first housing 11a may vary. As a result, the amount in which the needles 1310 among multiple channels (nozzles), which may also be referred to simply as CHs in the following description, may vary. Specifically, for example, the concentricity and parallelism between the central axis of the needle 1310 and the central axis of an inner wall face of the first housing 11a on which the O-ring 1034 slides, the flatness and roughness of the inner wall face of the first housing 11a on which the O-ring 1034 slides may affect the sliding resistance of the O-ring 1034. Accordingly, the sliding resistance of the O-ring 1034 may fluctuate. In the liquid discharge module 1030 of the comparative example illustrated in FIG. 5, the sliding resistance of the O-ring 1034 caused by the movement of the on-off valve 1031 may fluctuate. As a result, the amount of movement and the movement speed of the on-off valve 1031 may fluctuate. Accordingly, the discharge performances of the on-off valve 1031 among the multiple CHs may also fluctuate.

For this reason, the liquid discharge module 30 according to embodiments of the present disclosure has a configuration described below.

### First Embodiment

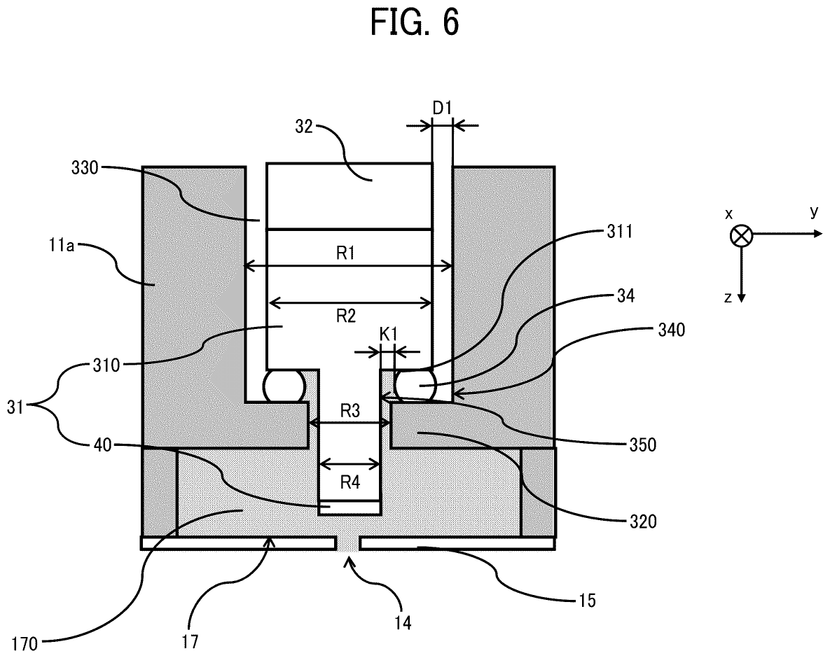

FIG. 6 is a diagram illustrating the liquid discharge module 30 according to a first embodiment of the present disclosure. The liquid discharge module 30 of the first embodiment is described with reference to FIG. 6.

In embodiments of the present disclosure, to solve the above-described disadvantages of the liquid discharge module 1030 of the comparative example, an O-ring that serves as the sealing member 34 is held by the needle 310 of the on-off valve 31 and walls of the channel 17 in the vicinity of the nozzle 14 of the liquid discharge module 30 as illustrated in FIG. 6. A description is given of the above-described configuration of the liquid discharge module 30 in detail below. The configuration of the liquid discharge module 30 other than the above-described portion in the vicinity of the nozzle 14 is similar to the configuration of the liquid discharge module 1030 according to the comparative example.

First, the needle 310 of the on-off valve 31 in the present embodiment includes a sealing-member holding portion 311 extending in a direction, i.e., y-axis direction, perpendicular to the movement direction of the needle 310, i.e., z-axis direction. In addition, in the present embodiment, the liquid discharge module 30 includes a sealing-member holding wall portion 320. The sealing-member holding wall portion 320 is a portion of the wall of the channel 17, i.e., the liquid chamber, connected to the first housing 11a which is a portion of the housing of the liquid discharge head 10 and extends in a direction perpendicular to the movement direction of the needle 310.

In the present embodiment, the sealing member 34, which serves as a sealing member, is held by the sealing-member holding portion 311, which serves as a first holding portion, and the sealing-member holding wall portion 320, which serves as a second holding portion. The sealing-member holding portion 311 and the sealing-member holding wall portion 320 are positioned to partially overlap each other when viewed from the movement direction of the on-off valve 31 and the needle 310.

The sealing member 34 and the first housing 11a are spaced apart from each other by a predetermined clearance or gap, which may also be referred to simply as a clearance (gap) D1 in the present embodiment. This is because the sealing member 34 is disposed such that the sealing member 34 is separated by the predetermined clearance, i.e., the clearance (gap) D1, from a housing sealing-member facing surface 340 (side face). The housing sealing-member facing surface 340 is a portion of an inner wall face (side face) of the first housing 11a, which serves as a housing sealing-member facing surface, facing the sealing member 34 in a direction, i.e., a direction in a X-Y plane, perpendicular to the movement direction of the on-off valve 31.

The sealing-member holding wall portion 320 serves as a bottom face of the first housing 11a, and the housing sealing-member facing surface 340 (side face) and the sealing-member holding wall portion 320 (bottom face) define the first housing 11a to accommodate the piezoelectric element 32 (mover) and a part of the needle 310 of the on-off valve 31.

The sealing member 34 and the needle 310 are also separated by a predetermined clearance or a gap, i.e., a clearance K1, in the present embodiment. This is because the sealing member 34 is disposed such that the sealing member 34 is separated by the predetermined clearance, i.e., the clearance (gap) K1, from an on-off valve sealing member facing surface 350, which is a portion of the circumferential surface of the needle 310 opposed to the sealing member 34, in a direction perpendicular to the longitudinal direction of the needle 310. In other words, in cross sections of the sealing member 34 perpendicular to the movement direction of the on-off valve 31, there is no identical cross section of the sealing member 34 in which the sealing member 34 is coupled to both the needle 310 and the first housing 11a at a same time.

Thus, the liquid discharge head 10 includes the nozzle plate 15 having the nozzles 14 from which the liquid is dischargeable in a discharge direction. Each of the liquid discharge modules 30 of the liquid discharge head 10 includes the needle valve 31, a mover such as the piezoelectric element 32, a housing such as the housing 11a, and a sealing member such as the sealing member 34. The needle valve 31 includes a first part having a first diameter and a second part having a second diameter smaller than the first part. The second part has a leading end contactable with the nozzle to close the nozzle. The needle valve is movable in the discharge direction between a separation position at which the leading end of the second part of the needle valve is separated from the nozzle to open the nozzle and a contact position at which the leading end of the second part of the needle valve contacts the nozzle to close the nozzle. The piezoelectric element 32 as the mover moves the needle valve 31 in the discharge direction. The housing 11a has a side wall extending in the discharge direction, a bottom wall such as the sealing-member holding wall portion 320 perpendicular to the side wall, and a liquid chamber such as the channel 17. The side wall and the bottom wall defines a container such as the piezoelectric element container 330 containing the mover inside the housing 11a. The liquid chamber communicates with the nozzle. The sealing member is disposed between the first part of the needle valve and the bottom wall of the housing in the discharge direction to seal the container from the liquid chamber. The sealing member is deformable in the discharge direction in accordance with the movement of the needle valve.

The first part of the needle valve has a first contact face to contact one face of the sealing member. The bottom wall of the housing has a second contact face to contact another face opposite to the one face of the sealing member. The sealing member contacts the first contact face of the needle valve and the second contact face of the bottom wall of the housing.

A description is given of the sealing member 34 according to the present embodiment below. The sealing member 34 has a shape such that the sealing member 34 seals the ink 170 at each of connecting portions between the needle 310 and the first housing 11a, walls of the channel 17, i.e., the liquid chamber, or the sealing-member holding wall portion 320, and has a hole, i.e., a space, through which the needle 310 passes through. An O-ring shape, a cylindrical shape, or a shape obtained by forming a hole in a polygonal column can be applied to the sealing member 34. In the present embodiment, an O-ring is employed for the sealing member 34.

The sealing member 34 is inserted into a portion disposed in the sealing-member holding wall portion 320, such as a groove into which a sealing member is inserted, to be mounted. The sealing member 34 can be mounted without being fixed to the sealing-member holding portion 311 and the sealing-member holding wall portion 320 by using, for example, an adhesive. The sealing member 34 can also be fixed.

The size of the sealing member 34 is not particularly limited as long as a predetermined clearance can be secured between the cross sections of the sealing member 34, perpendicular to the movement direction of the on-off valve 31 and the needle 310 and the first housing 11a. However, the size of the sealing member 34 in the movement direction of the on-off valve 31 is preferably equal to or larger than the 1 mm. The inner diameter of the hole of the sealing member 34 is 1 mm at minimum, and the outer diameter of the hole of the sealing member 34 is about 3 mm.

The sealing margin of the sealing member 34 in the movement direction of the on-off valve 31 and the needle 310 is equal to or larger than the sealing margin of a valve 40 to be described below. The sealing member 34 is deformed, for example, compressed, in the movement direction of the needle 310. However, the amount of deformation of the sealing member 34 is preferably set to equal to or greater than the amount of movement of the needle 310, which is 20 to 50 μm, or 100 μm at the maximum. In the present embodiment, the amount of deformation of the sealing member 34 is set to 300 to 500 μm.

The sealing member 34 is preferably made of, for example, rubber, resins, elastomers, and may be made of any other material as long as the sealing member 34 can seal ink. The material of the sealing member 34, preferably, have properties such as chemical resistance and solvent resistance. In view of the above circumstances, for example, Perflo 4275B (registered trademark), manufactured by Morikiyo Chemical Industries, Ltd. may be used as the material of the sealing member 34.

In the present embodiment, an O-ring is employed for the sealing member 34.

When the sealing member 34 is installed between the needle 310 and the sealing-member holding wall portion 320, the sealing member 34 is installed such that the sealing member 34 is compressed in the movement direction of the needle 310. This is because the sealing member 34 contacts either one of the needle 310 and the sealing-member holding wall portion 320 in the radial direction of the sealing member 34, the position of the cross section of the sealing member 34 in the direction perpendicular to the movement direction of the needle 310 can be fixed. Accordingly, the assembly of the liquid discharge module 30 can be facilitated. For this reason, the sealing member 34 is disposed in a state in which the sealing member 34 is compressed to some extent from the beginning. In the present embodiment, the compression ratio of the sealing member 34, which is an O-ring, is about 30±10%.

Subsequently, a description is given of the on-off valve 31 below. The on-off valve 31 includes the needle 310, and the needle 310 includes the valve 40 at a tip end of the needle 310. The valve 40 that is disposed at the tip end of the needle 310 can seal the nozzle 14 and has a shape such that the valve 40 is coupled to the needle 310. The valve 40 is preferably made of, for example, rubber, resins, elastomers, and may be made of any other material as long as the valve 40 can seal ink.

The needle 310 preferably has a cylindrical shape such that the needle 310 seals the ink 170 at connecting portions between the needle 310 and the sealing member 34. The material of the needle 310 is preferably stainless steel. However, other metals or resins may be employed as long as the other metals or resins have resistance to ink. The needle 310 is coupled to the piezoelectric element 32, which is a driving mechanism and a moving unit of the on-off valve 31 including the needle 310.

A description is given of the housing of the liquid discharge head 10 below. The first housing 11a that serves as the portion of the housing of the liquid discharge head 10, the walls of the channel 17, i.e., the liquid chamber, or the sealing-member holding wall portion 320 each has a shape capable of sealing the ink 170 at portions connecting a space through which the needle 310 passes and the sealing member 34. The first housing 11a that serves as the portion of the housing of the liquid discharge head 10, the walls of the channel 17 as the liquid chamber, or the sealing-member holding wall portion 320 are preferably, formed of stainless steel. However, other metals or resins may be employed as long as the metals or the resins have resistance to ink.

In the configuration according to the present embodiment, the sealing member 34 and the needle 310 are simply inserted into the housing of the liquid discharge module 30, including, for example, the first housing 11a. Accordingly, the housing of the liquid discharge module 30 can be easily assembled.

The diameter of the needle 310 and the size of, for example, the piezoelectric element container 330, which serves as a moving-unit container, according to the present embodiment are described below. As illustrated in FIG. 6, the inner diameter of the piezoelectric element container 330 is R1, the outer diameter of a portion of the needle 310, coupled to the piezoelectric element 32, i.e., a portion of the needle 310 having a larger outer diameter, is R2, the inner diameter of a hole of the sealing-member holding wall portion 320, closer to the nozzle 14, into which a portion of the needle 310 is inserted, i.e., a portion of the needle 310 having a smaller outer diameter, is R3, and the outer diameter of a portion of the needle 310, closer to the nozzle 14 is R4. From the viewpoint of arranging the nozzles 14 in high density, it is desirable to minimize the size of the entire outer diameter of the needle 310 and the clearance between the needle 310 and the first housing 11a. In view of the above circumstances, in the present embodiment, R2 is set to 2 to 5 mm, R4 is set to 1 to 2 mm, R1 is set to a value calculated from a formula of R1−R2 (i.e., the clearance D1)=0.5 to 1.5 mm, and R3 is set to a value calculated from a formula of R3−R4=0.5 to 1.5 mm.

Functions of Sealing Member when Nozzle is Opened and Closed

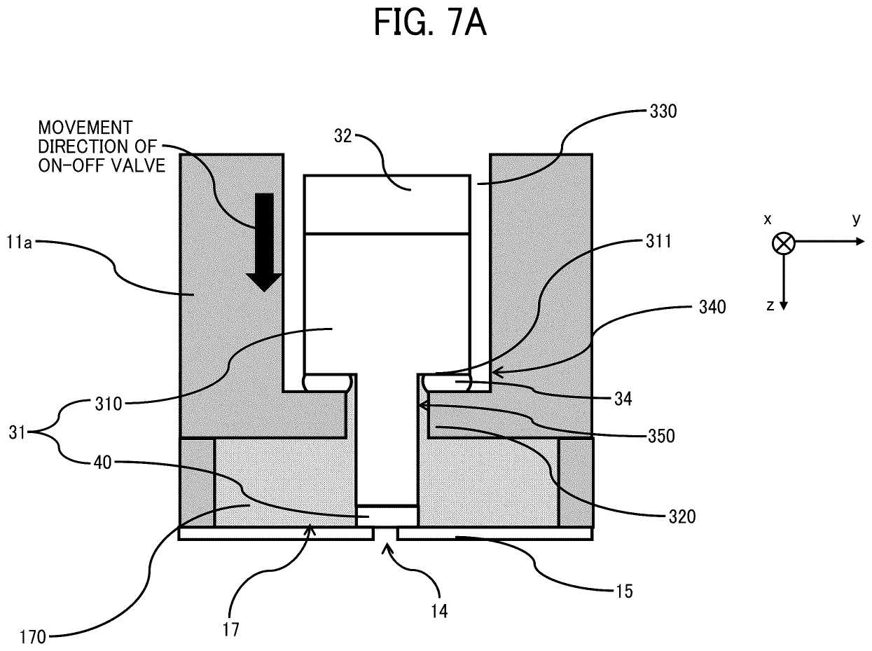

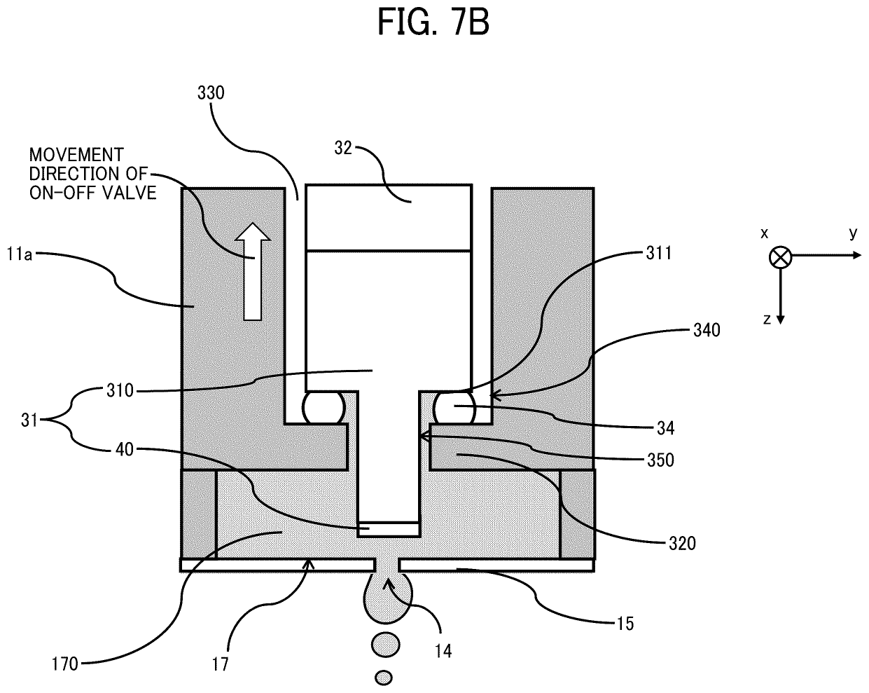

Next, a description is given of a sealing member 34 of the present embodiment when the nozzle 14 is opened and closed with reference to FIGS. 7A and 7B. FIG. 7A is a diagram illustrating the liquid discharge module 30, indicating how the sealing member 34 operates when the nozzle 14 is closed. FIG. 7B is a diagram illustrating the liquid discharge module 30, indicating how the sealing member 34 operates when the nozzle 14 is opened.

First, when the nozzle 14 is closed, i.e., when ink is not discharged, as illustrated in FIG. 7A, the valve 40 contacts the nozzle plate 15, and the on-off valve 31 including the needle 310 seals the nozzle 14. At this time, the sealing member 34 is deformed in a direction in which the on-off valve 31 including the needle 310 moves, as indicated by black arrow. The sealing member 34 seals the ink 170 with the sealing member 34 being coupled to the needle 310 and the sealing-member holding wall portion 320. At this time, the sealing member 34 is compressed to some extent from a moment at which the sealing member 34 is installed. However, when the nozzle 14 is closed, the sealing member 34 is pressed by the needle 310 and the sealing-member holding wall portion 320 which sandwich the sealing member 34. Accordingly, the sealing member 34 is further compressed and crushed.

When the nozzle 14 is opened, i.e., when the ink 170 is discharged, the on-off valve 31 including the needle 310 and the nozzle plate 15 are separated from each other by the piezoelectric element 32 as illustrated in FIG. 7B. At this time, the sealing member 34 is deformed in the direction in which the on-off valve 31 including the needle 310 moves, as indicated by blank arrow. The sealing member 34 seals the ink 170 in a state in which the sealing member 34 is coupled to, i.e., contacts the needle 310 and the sealing-member holding wall portion 320, similar to the time in which the nozzle 14 is closed.

In the present embodiment, when the ink 170 is discharged, preferably, a distance, i.e., a gap amount, between the on-off valve 31 and the nozzle plate 15 does not exceed the sealing margin of the sealing member 34 in the movement direction of the on-off valve 31. This is because if the distance between the on-off valve 31 and the nozzle plate 15 exceeds the sealing margin of the sealing member 34, the ink 170 flows into the piezoelectric element container 330 including the driving mechanism. As a result, the driving mechanism such as the piezoelectric element 32 may be damaged. Such a configuration as described above can prevent the driving mechanism from being damaged.

The sealing member 34 is deformed only in the moving direction of the on-off valve 31 when the on-off valve 31 moves between a position at which the on-off valve 31 closes the nozzle 14 in FIG. 7A and a position at which the on-off valve 31 opens the nozzles 14 in FIG. 7B. For this reason, the sealing member 34 does not slide on either the on-off valve 31 or the first housing 11a. Accordingly, the sliding resistance of the sealing member 34 to be generated in accordance with the movement of the on-off valve 31 is not generated. In addition, the repulsive force of the sealing member 34, which is generated when the sealing member 34 is compressed and deformed in the moving direction of the on-off valve 31, repels the movement of the on-off valve 31 when the on-off valve 31 is closed. Accordingly, the repulsive force of the sealing member 34 promotes the movement of the on-off valve 31 when the on-off valve 31 opens the nozzle 14. The amount of the repulsive force of the sealing member 34 depends on the amount of the sealing member 34 being crushed and is not affected by the shaft misalignment or the shaft inclination of the on-off valve 31. Accordingly, even when the shaft of the on-off valve 31 is misaligned or inclined, the movement amount or the movement speed of the on-off valve 31 is less likely to fluctuate.

In embodiments of the present disclosure, the sealing member 34 is held by the sealing-member holding portion 311 and the sealing-member holding wall portion 320. The sealing-member holding portion 311 and the sealing-member holding wall portion 320 are positioned to partially overlap each other when viewed from the movement direction of the on-off valve 31, i.e., the needle 310. The sealing member 34 and the first housing 11a are separated by a predetermined clearance, i.e., the clearance D1 in the present embodiment. In embodiments of the present disclosure, such a configuration as described above can prevent, for example, uneven compression of the sealing member 34 in the radial direction due to the shaft misalignment of the needle 310 and inclination or torsion of the sealing member 34 when the sealing member 34 is mounted. Accordingly, even when the axis of the needle 310 is misaligned or inclined when the needle 310 is mounted, the liquid discharge head 10 of the present embodiment is less likely to be affected by the variation in resistance caused by the movement of the on-off valve 31 and the variation in the movement amount or the movement speed of the on-off valve 31 is reduced. As a result, the variation in the discharge performance of the liquid discharge head 10 can be reduced.

### Second Embodiment

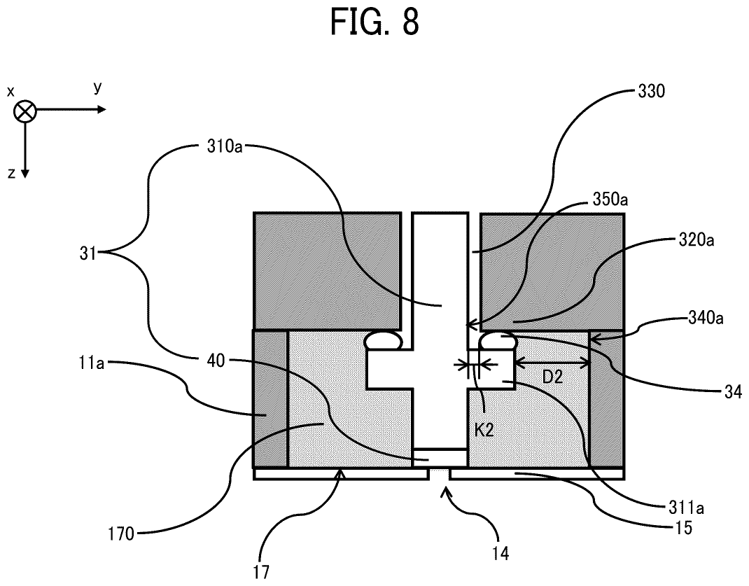

FIG. 8 is a diagram illustrating the liquid discharge module 30 according to a second embodiment of the present disclosure. A description is given of the liquid discharge module according to the second embodiment with reference to FIG. 8 below. A description is given of differences between the first embodiment and the second embodiment below.

First, a needle 310a of the on-off valve 31 of the present embodiment includes a sealing-member holding portion 311a extending in a direction, i.e., the y axis direction, perpendicular to the movement direction of the needle 310a, i.e., the z axis direction. In the present embodiment, a sealing-member holding wall portion 320a is disposed as a portion of the wall of the channel 17, i.e., the liquid chamber connected to the first housing 11a, which serves as the housing of the liquid discharge head 10. The sealing-member holding wall portion 320a extends in the direction perpendicular to the movement direction of the needle 310a. In the present embodiment, the sealing member 34 is held by the sealing-member holding portion 311a and the sealing-member holding wall portion 320a. The sealing-member holding portion 311a and the sealing-member holding wall portion 320a are positioned to partially overlap each other when viewed from the movement direction of the on-off valve 31 including the needle 310a. A predetermined clearance D2 is disposed between the sealing member 34 and the first housing 11a. Specifically, the sealing member 34 is disposed to be separated by the predetermined clearance, i.e., the clearance D2, from the housing sealing-member facing surface 340a, which is a portion of the inner wall face of the first housing 11a facing the sealing member 34 in the direction, i.e., a direction along the X-Y plane in FIG. 8, perpendicular to the movement direction of the on-off valve 31. In addition, a predetermined clearance, i.e., a clearance K2, is disposed between the sealing member 34 and the needle 310a in the present embodiment. Specifically, the sealing member 34 is disposed to be separated by the predetermined clearance, i.e., the clearance K2, from an on-off valve sealing member facing surface 350a, which is a portion of the surface of the needle 310a facing the sealing member 34 in the direction perpendicular to the movement direction of the needle 310a. In other words, in cross sections of the sealing member 34 perpendicular to the movement direction of the on-off valve 31, there is no identical cross section of the sealing member 34 in which the sealing member 34 is coupled to both the needle 310 and the first housing 11a at a same time.

The configuration of the present embodiment is different from the configuration of the first embodiment in that the sealing-member holding portion 311a of the needle 310a is positioned closer to the nozzle 14 than the sealing-member holding wall portion 320a forming a portion of the walls of the first housing 11a. In other words, a connecting portion, i.e., a contact portion, between the sealing member 34 and the sealing-member holding portion 311a of the needle 310a is closer to the nozzle 14 than a connecting portion, i.e., a contact portion, between the sealing member 34 and the sealing-member holding wall portion 320a. The sealing member 34 is compressed to some extent from the time at which the sealing member 34 is mounted, which is similar to the first embodiment.

In the present embodiment, for example, when the needle 310a moves upward, i.e., in a direction opposite the z-axis direction in FIG. 8, such as when the nozzle 14 is opened, the sealing member 34 is pressed by the needle 310a and the sealing-member holding wall portion 320a which sandwich the sealing member 34. Accordingly, the sealing member 34 is further compressed.

The sealing member 34 of the present embodiment is disposed in a state in which the sealing member 34 is compressed. However, the sealing member 34 is deformed by the elasticity of the sealing member 34. Accordingly, the sealing member 34 biases the needle 310a downward, i.e., in a direction indicated by the arrow of the z-axis direction in FIG. 8. Thus, the sealing member 34 pushes the needle 310a toward the nozzle 14. Accordingly, the pressing force of the on-off valve 31 against the nozzle 14 increases. Thus, the sealing performance between the valve 40 and the nozzle 14 can be enhanced.

### Third Embodiment and Fourth Embodiment

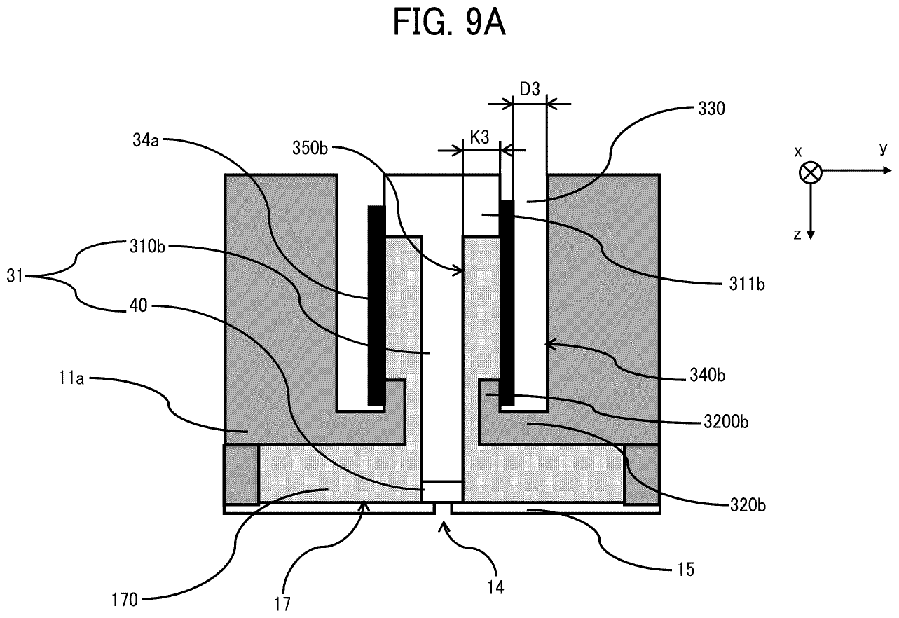

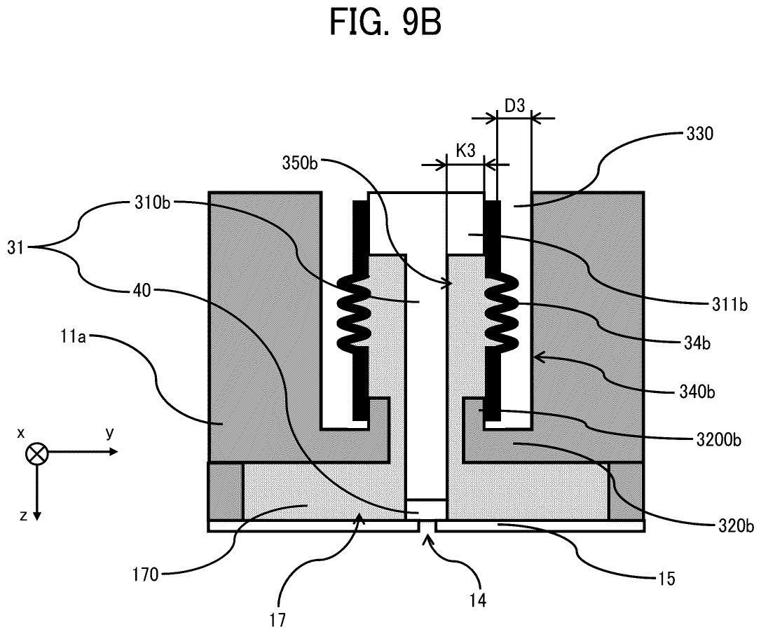

FIGS. 9A and 9B are diagrams each illustrating of the liquid discharge module 30 according to the third embodiment and the fourth embodiment, respectively. FIG. 9A is a diagram illustrating the liquid discharge module 30 according to the third embodiment. FIG. 9B is a diagram illustrating the liquid discharge module 30 according to the fourth embodiment. A description is given of differences between the liquid discharge module 30 of the third and the fourth embodiments and the liquid discharge module 30 of the first embodiment.

First, the liquid discharge module 30 of the third embodiment is described. As illustrated in FIG. 9A, the needle 310b of the on-off valve 31 of the present embodiment includes a sealing-member holding portion 311b extending in a direction, i.e., the y-axis direction, perpendicular to the movement direction of the needle 310b, i.e., the z-axis direction. In the present embodiment, a sealing-member holding wall portion 320b is disposed as a portion of the wall of the channel 17, i.e., the liquid chamber connected to the first housing 11a, which serves as the housing of the liquid discharge head 10. The sealing-member holding wall portion 320b extends in a direction perpendicular to the movement direction of the needle 310b.

In the present embodiment, a sealing member 34a is held by the sealing-member holding portion 311b and the sealing-member holding wall portion 320b. The sealing-member holding portion 311b and the sealing-member holding wall portion 320b are positioned to partially overlap each other when viewed from the movement direction of the on-off valve 31 including the needle 310b. A predetermined clearance D3 is disposed between the sealing member 34a and a housing sealing-member facing surface 340b in a direction, i.e., the y-axis direction in FIG. 9A, perpendicular to the movement direction of the on-off valve 31 including the needle 310b. The housing sealing-member facing surface 340b is an inner wall face of the piezoelectric element container 330 of the first housing 11a and is a surface facing the sealing member 34a. The sealing member 34a is disposed to be separated by a predetermined clearance, i.e., a clearance K3, from an on-off valve sealing member facing surface 350b, which is a portion of the surface of the needle 310b facing the sealing member 34a in the direction perpendicular to the movement direction of the needle 310b. In other words, in cross sections of the sealing member 34a perpendicular to the movement direction of the on-off valve 31, no identical cross section of the sealing member 34a in which the sealing member 34a is coupled to both the needle 310b and the first housing 11a at a same time.

A description is given of the sealing member 34a according to the present embodiment below. The sealing member 34a has a cylindrical tubular shape. Accordingly, unlike the O-ring illustrated in the embodiments described above, the sealing member 34a is, for example, extended by the movement of the needle 310b. The sealing member 34a is preferably made of, for example, rubber, resins, elastomers, and may be made of any other material as long as the sealing member 34a can seal ink. The material of the sealing member 34a, preferably, have properties such as chemical resistance and solvent resistance. For example, Perflo 4275B (registered trademark), manufactured by Morikiyo Chemical Industries, Ltd. may be used as the material of the sealing member 34a. The tensile force of the sealing member 34a is preferably as small as possible to reduce the sliding resistance of the needle 310b when the needle 310b is driven to move. Ink can be sealed at each of the connecting portions between the needle 310b and the first housing 11a, the walls of the channel 17, i.e., the liquid chamber, or the sealing-member holding wall portion 320b. Next, a description is given of the needle 310b below. The needle 310b has, preferably, a cylindrical shape. The needle 310b has a shape capable of sealing the ink 170 in the radial direction of the needle 310b with the sealing member 34a. Specifically, the needle 310b includes the sealing-member holding portion 311b that extends in the direction perpendicular to the movement direction of the needle 310b as described above. The sealing-member holding portion 311b is inserted into the hole of the tubular sealing member 34a. Accordingly, the sealing member 34a can be held by the sealing-member holding portion 311b. Accordingly, the sealing-member holding portion 311b is coupled to and contacts the inner circumferential surface of the hole of the sealing member 34a at portions of the sealing member 34a in the direction parallel to the movement direction of the needle 310b. As a result, the ink 170 can be prevented from entering the piezoelectric element container 330.

The material of the needle 310b is preferably stainless steel. However, other metals or resins may be employed as long as the other metals or resins have resistance to ink. The needle 310c is coupled to the piezoelectric element 32, which serves as a driving mechanism and a moving member to move the on-off valve 31 including the needle 310b.

Next, the first housing 11a of the liquid discharge head 10 is described below. The first housing 11a that serves as a portion of the housing of the liquid discharge head 10, the walls of the channel 17, i.e., the liquid chamber, or the sealing-member holding wall portion 320b, each has a shape capable of sealing the ink 170 at connecting portions between a space through which the needle 310b passes and the sealing member 34a. A description is given of the sealing-member holding wall portion 320b in detail below. The sealing-member holding wall portion 320b extends in the direction perpendicular to the movement direction of the needle 310b as described above. The sealing-member holding wall portion 320b includes a vertical wall portion 3200b extending in a direction parallel to the movement direction of the needle 310b in the vicinity of the needle 310b. The vertical wall portion 3200b extends such that the vertical wall portion 3200b protrudes toward the piezoelectric element 32 from a portion of the sealing-member holding wall portion 320b extending in the direction perpendicular to the movement direction of the needle 310b.

The hole of the tubular sealing member 34a is inserted into the vertical wall portion 3200b of the sealing-member holding wall portion 320b, such that the sealing member 34a is held by the sealing-member holding wall portion 320b. Accordingly, the sealing-member holding wall portion 320b is coupled to and contacts the inner circumferential surface of the hole of the sealing member 34a at a portion of the sealing-member holding wall portion 320b parallel to the movement direction of the needle 310b. As a result, the ink 170 can be prevented from entering the piezoelectric element container 330.

The first housing 11a that serves as a portion of the housing of the liquid discharge head 10, the walls of the channel 17 as the liquid chamber, or the sealing-member holding wall portion 320 are preferably, formed of stainless steel. However, other metals or resins may be employed as long as the metals or the resins have resistance to ink.

In the present embodiment, the sealing member 34a has a tubular shape. Accordingly, ink can be sealed in the radial direction of the sealing member 34a. In addition, the slide load on the needle 310b that is generated when the sealing member 34a is deformed in a direction in which the sealing member 34a is driven to move.

Subsequently, a description is given of a sealing member of the fourth embodiment below. The shape of the sealing member of the fourth embodiment is different from the shape of the sealing member 34a of the third embodiment. Other configurations of the fourth embodiment are similar to the configurations of the third embodiment. For this reason, a description is given of differences between the sealing member 34a of the third embodiment and the sealing member of the fourth embodiment.

As illustrated in FIG. 9B, a sealing member 34b according to the present embodiment has a cylindrical tubular shape. In addition, the sealing member 34b includes an expansion and contraction portion which can expand and contract in a direction in which the needle 310b is driven to move. Examples of the shape of the expansion and contraction portion include a bellows shape, a thin shape.

The material of the sealing member 34b is not particularly limited as long as the material can seal the ink. However, the expansion and contraction portion is preferably formed of a material having high elasticity such that the sealing member 34b is more greatly deformable by a similar force as a force applied to other portions of the sealing member 34b. For this reason, the material of the sealing member 34b is preferably, for example, rubber, resin, or elastomer. In addition, the material of the sealing member 34b, preferably, have properties such as chemical resistance and solvent resistance. For example, Perflo 4275B (registered trademark), manufactured by Morikiyo Chemical Industries, Ltd. may be used as the material of the sealing member 34a.

In the present embodiment, the stress of the sealing member 34b that is generated when the sealing member 34b is deformed in a direction in which the sealing member 34b is driven to move can be reduced in the expansion and contraction portion of the sealing member 34b. Accordingly, the slide load that is applied to the needle 310b can be reduced.

### Fifth Embodiment

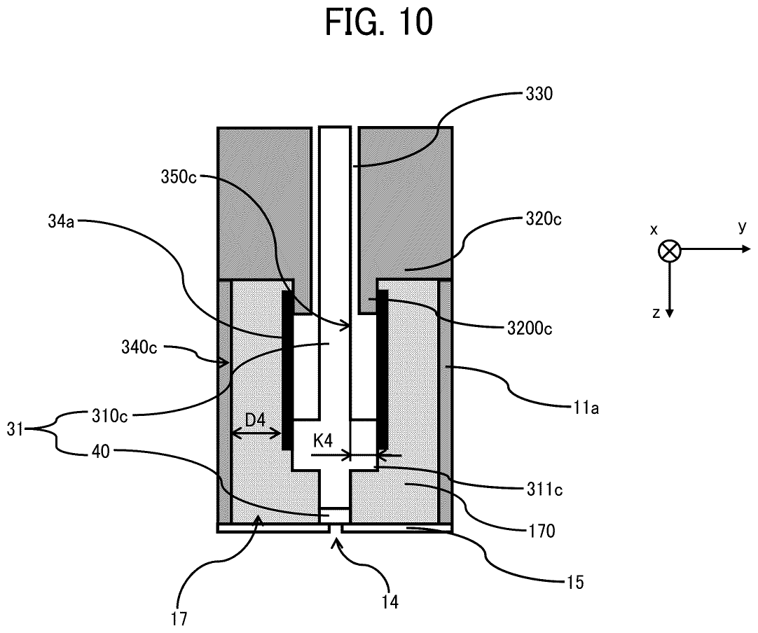

FIG. 10 is a diagram illustrating the liquid discharge module 30 according to a fifth embodiment of the present disclosure. A description is given of the liquid discharge module according to the fifth embodiment with reference to FIG. 10 below. The shape of a needle and the first housing 11a of the fifth embodiment is different from the shape of the needle 310b and the first housing 11a of the third embodiment. Other components of the fifth embodiment are similar to the components of the third embodiment. For this reason, a description is given of differences between the third embodiment and the fifth embodiment.

As illustrated in FIG. 10, a needle 310c of the on-off valve 31 of the present embodiment includes a sealing-member holding portion 311c extending in a direction, i.e., the y-axis direction, perpendicular to the movement direction of the needle 310c, i.e., the z-axis direction. In the present embodiment, a sealing-member holding wall portion 320c is disposed as a portion of the wall of the channel 17, i.e., the liquid chamber connected to the first housing 11a, which serves as the housing of the liquid discharge head 10. The sealing-member holding wall portion 320c extends in a direction perpendicular to the movement direction of the needle 310c. In the present embodiment, the sealing member 34a is held by the sealing-member holding portion 311c and the sealing-member holding wall portion 320c. The sealing-member holding portion 311c and the sealing-member holding wall portion 320c are positioned to partially overlap each other when viewed from the movement direction of the on-off valve 31 including the needle 310c. A predetermined clearance D4 is disposed between the sealing member 34a and a housing sealing-member facing surface 340c in a direction, i.e., the Y-axis direction, perpendicular to the movement direction of the on-off valve 31 including the needle 310c. The housing sealing-member facing surface 340c serves as a portion of the first housing 11a and is a surface facing the sealing member 34a. The sealing member 34a is disposed to be separated by a predetermined clearance, i.e., a clearance K4, from an on-off valve sealing member facing surface 350c, which is a portion of the surface of the needle 310c facing the sealing member 34a in the direction perpendicular to the movement direction of the needle 310c. In other words, in cross sections of the sealing member 34a perpendicular to the movement direction of the on-off valve 31, no identical cross section of the sealing member 34a in which the sealing member 34a is coupled to both the needle 310c and the first housing 11a at a same time.

The configuration of the present embodiment is different from the configuration of the third embodiment in that the sealing-member holding portion 311c of the needle 310c is positioned closer to the nozzle 14 than the sealing-member holding wall portion 320c forming a portion of the walls of the first housing 11a. In other words, a connecting portion, i.e., a contact portion, between the sealing member 34a and the sealing-member holding portion 311c of the needle 310c is closer to the nozzle 14 than a connecting portion, i.e., a contact portion, between the sealing member 34a and the sealing-member holding wall portion 320c.

A description is given of the sealing member 34a according to the present embodiment below. The sealing member 34a has a cylindrical tubular shape similar to the third embodiment. Accordingly, the sealing member 34a, for example, extends by the movement of the needle 310c. The sealing member 34a is preferably made of, for example, rubber, resins, elastomers, and may be made of any other material as long as the sealing member 34a can seal ink. The material of the sealing member 34a, preferably, have properties such as chemical resistance and solvent resistance. For example, Perflo 4275B (registered trademark), manufactured by Morikiyo Chemical Industries, Ltd. may be used as the material of the sealing member 34a. The tensile force of the sealing member 34a is preferably as small as possible, similar to the third embodiment, to reduce the sliding resistance of the needle 310c when the needle 310c is driven to move. Ink can be sealed at each of the connecting portions between the needle 310c and the first housing 11a, the walls of the channel 17, i.e., the liquid chamber, or the sealing-member holding wall portion 320c.

Subsequently, a description is given of the needle 310c below. The needle 310c has, preferably, a cylindrical shape. The needle 310c has a shape capable of sealing the ink 170 in the radial direction of the needle 310c with the sealing member 34a. Specifically, the needle 310c includes the sealing-member holding portion 311c that extends in the direction perpendicular to the movement direction of the needle 310c as described above. The sealing-member holding portion 311c is inserted into the hole of the tubular sealing member 34a. Thus, the sealing member 34a can be held by the sealing-member holding portion 311c. Accordingly, the sealing-member holding portion 311c is coupled to and contacts the inner circumferential surface of the hole of the sealing member 34a at portions of the sealing-member holding portion 311c in a direction parallel to the movement direction of the needle 310c. As a result, the ink 170 can be prevented from entering the piezoelectric element container 330.

The material of the needle 310c is preferably stainless steel. However, other metals or resins may be employed as long as the other metals or resins have resistance to ink. The needle 310c is connected to the piezoelectric element 32, which serves as a driving mechanism and a moving member to move the on-off valve 31 including the needle 310c.

Next, the first housing 11a of the liquid discharge head 10 is described below. The first housing 11a that forms a portion of the housing of the liquid discharge head 10, the walls of the channel 17, i.e., the liquid chamber, or the sealing-member holding wall portion 320c, each has a shape capable of sealing the ink 170 at connecting portions between a space through which the needle 310c passes and the sealing member 34a. A description is given of the sealing-member holding wall portion 320c in detail below. The sealing-member holding wall portion 320c extends in the direction perpendicular to the movement direction of the needle 310c as described above. The sealing-member holding wall portion 320c includes a vertical wall portion 3200c extending in a direction parallel to the movement direction of the needle 310c in the vicinity of the needle 310c. The vertical wall portion 3200c extends to protrude toward the nozzle 14 from a portion of the sealing-member holding wall portion 320c extending in a direction perpendicular to the movement direction of the needle 310c.

The hole of the tubular sealing member 34a is inserted into the vertical wall portion 3200c of the sealing-member holding wall portion 320c, such that the sealing member 34a can be held by the sealing-member holding wall portion 320c. Accordingly, the sealing-member holding wall portion 320c is coupled to and contacts the inner circumferential surface of the hole of the sealing member 34a at portions parallel to the movement direction of the needle 310c. As a result, the ink 170 can be prevented from entering the piezoelectric element container 330.

The first housing 11a that serves as a portion of the housing of the liquid discharge head 10, the walls of the channel 17 as the liquid chamber, or the sealing-member holding wall portion 320 are preferably, formed of stainless steel. However, other metals or resins may be employed as long as the metals or the resins have resistance to ink.

According to the present embodiment, when the needle 310c moves to form a gap, i.e., a gap amount, between the on-off valve 31 and the nozzle plate 15, the needle 310c moves in a direction in which the needle 310c is driven to move to increase the sealing margin of the sealing member 34a. Accordingly, the sealing property between the sealing member 34a and other components can be enhanced.

### Sixth Embodiment and Seventh Embodiment

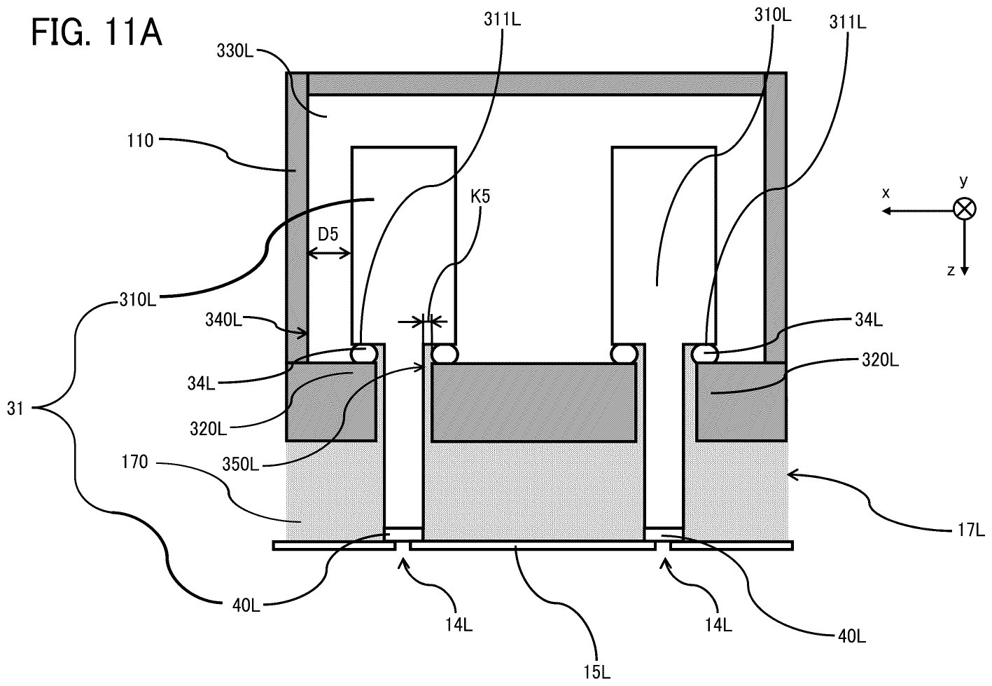

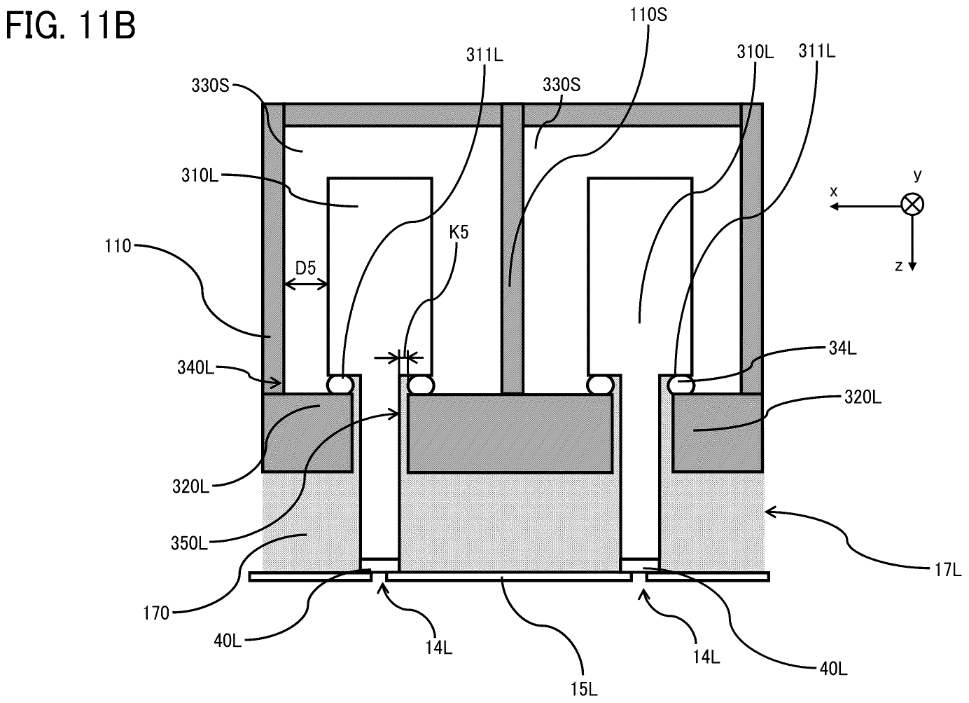

FIGS. 11A and 11B are diagrams each illustrating the liquid discharge module 30 according to a sixth embodiment and a seventh embodiment, respectively. In FIGS. 11A and 11B, the liquid discharge module 30 has a configuration in which multiple channels (CHs) are disposed, which may also be referred to simply as an array shape, and is different from the first embodiment in this respect. FIG. 11A is a diagram illustrating the liquid discharge module 30 according to the sixth embodiment. FIG. 11B is a diagram illustrating the liquid discharge module 30 according to the seventh embodiment. The array shape that is employed for the liquid discharge module 30 according to the sixth and seventh embodiments can also be applied to the above-described embodiments.

First, the liquid discharge module 30 according to the sixth embodiment is described with reference to FIG. 11A. In the liquid discharge module 30 of the sixth embodiment, the channels are connected to each other inside a space, i.e., a piezoelectric element container 330L, in an array housing 110 as a housing of the liquid discharge module 30. Thus, the CHs are integrated as a single component in the array shape. Other components of the present embodiment are similar to the components of the first embodiment. Accordingly, the components of the liquid discharge module 30 of the sixth embodiment that are different from the components of the above-described other embodiments are described below. The number of CHs is two in the present embodiment. However, the number of CHs may be three or greater than three in embodiments of the present disclosure.

As illustrated in FIG. 11A, in the present embodiment, the liquid discharge module includes the multiple driving units including nozzles 14L and needles 310L. Specifically, in the present embodiment, the liquid discharge module 30 includes the multiple nozzles 14L disposed on the nozzle plate 15L, on-off valves each including a valve 40L and the needle 310L corresponding to each of the nozzles 14L, and multiple sealing members 34L which are O-rings.

The needle 310L of each of the on-off valves 31 includes a sealing-member holding portion 311L extending in a direction, i.e., the x-axis direction, perpendicular to the movement direction of the needle 310L, i.e., the z-axis direction. In the present embodiment, a sealing-member holding wall portion 320L is disposed as a portion of the wall of the channel 17, i.e., the liquid chamber connected to the array housing 110, which serves as the housing of the liquid discharge module 30. The sealing-member holding wall portion 320L extends in a direction perpendicular to the movement direction of the needle 310L. The sealing-member holding wall portion 320L includes holes into which the needles 310L can be inserted. The number of the holes correspond to the number of the needles 310L.

In the present embodiment, the above-described sealing member holding portion 311L and the sealing-member holding wall portion 320L hold the sealing member 34L. The sealing-member holding portion 311L and the sealing-member holding wall portion 320L are positioned to partially overlap each other when viewed from the movement direction of the needle 310L. A predetermined clearance D5 is disposed between the sealing member 34L and a housing sealing-member facing surface 340L in a direction, i.e., the x-axis direction, perpendicular to the movement direction of the on-off valve 31 including the needle 310L. The housing sealing-member facing surface 340L serves as a portion of the array housing 110 and is a surface facing the sealing member 34L. The sealing member 34L is disposed to be separated by a predetermined clearance, i.e., a clearance K5, from an on-off valve sealing member facing surface 350L, which is a portion of the surface of the needle 310L facing the sealing member 34L in the direction perpendicular to the movement direction of the needle 310L. In other words, in cross sections of the sealing member 34L perpendicular to the movement direction of the on-off valve 31, no identical cross section of the sealing member 34L in which the sealing member 34L is coupled to both the needle 310L and components of the array housing 110 at a same time.

In embodiments of the present disclosure, in contrast to the array shape, for example, a configuration in which one needle is disposed relative to one nozzle as in the first embodiment, in other words, a configuration that is not an array shape is referred to as an individual unit shape. The array shape has following advantages as compared with the individual unit shape. First, in the case of the individual unit shape, liquid chambers, and components for injecting liquid such as ink into the liquid chambers are disposed. As a result, the cost of the liquid discharge apparatus increases. In addition, in the case of the individual unit shape, adjustment processes such as, for example, fastening with screws and positioning of components are needed. However, the cost of the adjustment processes further increases the cost of the liquid discharge apparatus in addition to the cost of the components. The cost increase of the liquid discharge apparatus is more remarkable in the case of the individual unit shape than in the case of the array shape.

In contrast, in the array shape, it is sufficient that a single component for injecting liquid such as ink into the liquid chamber is disposed. Accordingly, the number of components can be reduced. As described above, the number of components can be reduced. For this reason, the number of adjustment processes such as fastening with screws and positioning of the components can also be reduced. Accordingly, the cost of performing such processes can also be reduced.

Next, a description of the liquid discharge module 30 according to the seventh embodiment is given below. As illustrated in FIG. 11B, the liquid discharge module 30 of the present embodiment is different from the liquid discharge module 30 of the sixth embodiment in that a partition 110S is disposed in a space inside the array housing 110, and piezoelectric element containers 330S which are individual spaces are provided for the respective CHs. Other components of the present embodiment are similar to the components of the third embodiment. As described above, in the array shape of the present embodiment, the piezoelectric element container 330S that contains the driving unit including the piezoelectric element coupled to the needle 310L may serve as an individual space for each CH.

Difference in Effect between Embodiments of the Present Disclosure and Comparative Example

The difference in effects between the above-described embodiments of the present disclosure and the comparative example is described below. First, in the comparative example, the sealing member, i.e., the O-ring 1034, is pressed in a direction perpendicular to the movement direction of the on-off valve 1031 including the needle 1310. Accordingly, in the comparative example, the needle 1310 slides against the sealing member, i.e., the O-ring 1034, or the sealing member slides against the first housing 11a when the on-off valve 1031 including the needle 1310 moves. Accordingly, sliding resistance is generated. In addition, when the sealing member, i.e., the O-ring 1034, is deformed, for example, twisted, in accordance with the movement of the needle 1310, a load is applied to the needle 1310 in a direction perpendicular to the movement direction of the needle 1310 due to the deformation of the sealing member. Accordingly, in the comparative example, the axis of the needle 1310 is likely to be misaligned, and the posture of the needle 1310 may be unstable. By contrast, in the above-described embodiments of the present disclosure, a load that is applied to the needle such as the needle 310, 310a, 310b, 310c, and 310L from the sealing member such as the sealing member 34, 34a, 34b, and 34L when the on-off valve 31 including the needle moves is only a load parallel to the movement direction of the on-off valve 31 including the needle. Accordingly, in the embodiments of the present disclosure, the axial misalignment of the needle is less likely to occur, and the posture of the needle is likely to be stable.

### Configuration of Liquid Discharge Apparatus

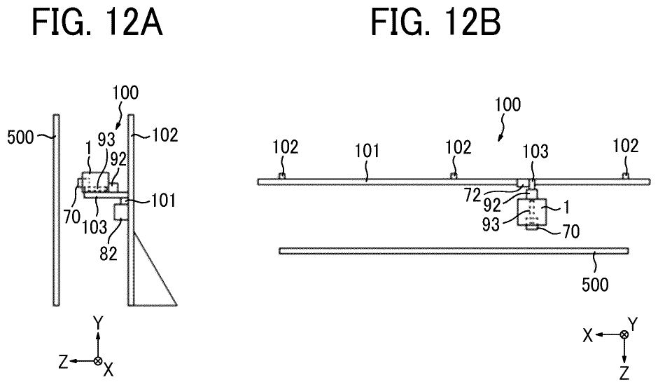

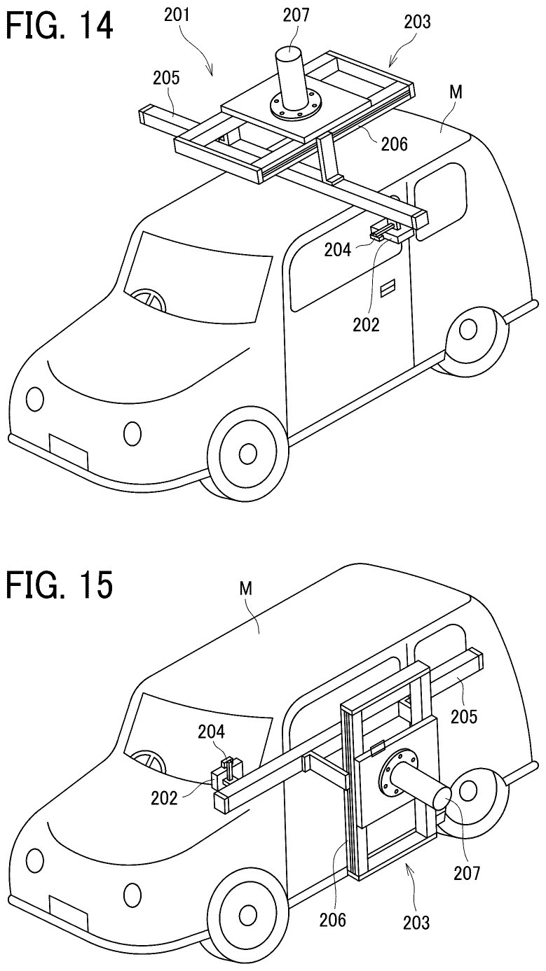

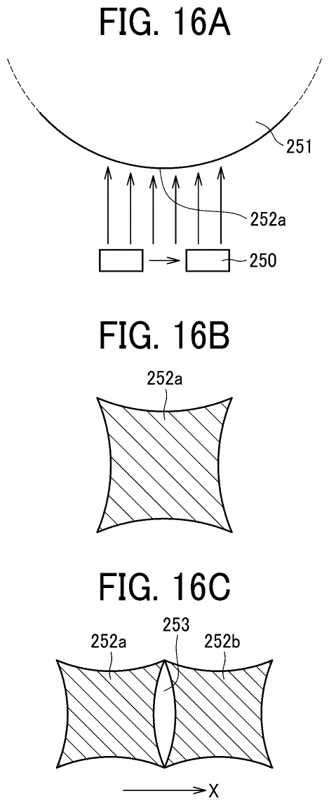

Next, a liquid discharge apparatus according to an embodiment of the present disclosure is described with reference to the drawings. The above-described embodiments can be applied to the configuration of the liquid discharge apparatus described below. X, Y, and Z directions illustrated in FIGS. 12A, 12B, and 16C of the present embodiment are different from the definitions of the coordinates illustrated in FIGS. 1A, 1B, 2, 3, 4, 5, 6, 7A, 7B, 8, 9A, 9B, 10, 11A, and 11B.

FIGS. 12A and 12B are diagrams each illustrating an overall schematic configuration of a liquid discharge apparatus 100, according to an embodiment of the present disclosure. FIG. 12A is a side view of the liquid discharge apparatus 100. FIG. 12B is a plan view of the liquid discharge apparatus 100. The liquid discharge apparatus 100 is installed to face a liquid application object 500 as a discharge object. The liquid discharge apparatus 100 includes an X-axis rail 101, a Y-axis rail 102 intersecting the X-axis rail 101, and a Z-axis rail 103 intersecting the X-axis rail 101 and the Y-axis rail 102. In particular, in the present embodiment, the X-axis rail 101, the Y-axis rail 102, and the Z-axis rail 103 extend in directions perpendicular to each other.

The Y-axis rail 102 holds the X-axis rail 101 such that the X-axis rail 101 can move in the Y direction. The X-axis rail 101 holds the Z-axis rail 103 such that the Z-axis rail 103 can move in the X direction. The Z-axis rail 103 holds a carriage 1, which serves as a discharge head support, such that the carriage 1 can move in the Z direction.

The liquid discharge apparatus 100 includes a first Z-direction driver 92 and an X-direction driver 72. The first Z-direction driver 92 moves the carriage 1 in the Z direction along the Z-axis rail 103. The X-direction driver 72 moves the Z-axis rail 103 in the X direction along the X-axis rail 101. The liquid discharge apparatus 100 also includes a Y-direction driver 82 to move the X-axis rail 101 in the Y direction along the Y-axis rail 102. The liquid discharge apparatus 100 further includes a second Z-direction driver 93 to move a head holder 70 in the Z direction with respect to the carriage 1.

The liquid discharge head 10 described above is attached to the head holder 70 such that the nozzles 14 (see FIG. 2) of the liquid discharge head 10 face the liquid application object 500. The liquid discharge apparatus 100 as described above discharges ink, which is an example of liquid, from the liquid discharge head 10 attached to the head holder 70 toward the liquid application object 500 to perform drawing on the liquid application object 500, while moving the carriage 1 in the X direction, the Y direction, and Z direction.

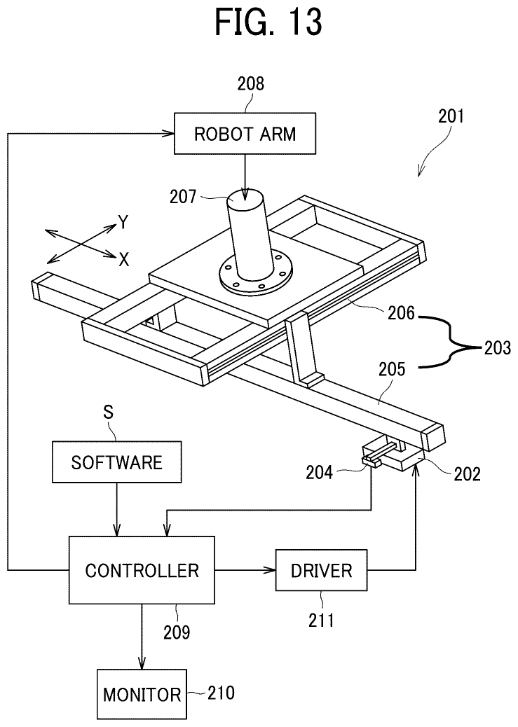

Subsequently, an inkjet printer 201, which is another example of the liquid discharge apparatus, is described below with reference to FIGS. 13, 14, and 15.

As illustrated in FIG. 13, the inkjet printer 201 according to an embodiment of the present disclosure includes, for example, a print head 202, an X-Y table 203, a camera 204, a controller 209, and a driver 211.

The print head 202 is an inkjet-type liquid discharge head that discharges ink, i.e., liquid, toward a surface to be printed of an object to be printed M. The term ink that is employed in the present embodiment includes paint. The print head 202 includes multiple valve-type nozzles, and ink is discharged from each of the valve-type nozzles in a direction perpendicular to the discharge surface of the print head 202. In other words, the ink discharge surface of the print head 202 is parallel to a X-Y plane formed by the movement of the X-Y table 203. Ink dots discharged from each of the valve-type nozzles are discharged in a direction perpendicular to the X-Y plane. The ink is discharged from the valve-type nozzles in parallel to each other. Each of the valve-type nozzles is connected to an ink tank of a predetermined color. The ink tank is pressurized by a pressing device. Accordingly, when the distances between the valve-type nozzles and a surface to be printed of the object to be printed M are approximately equal to 20 cm, ink dots can be discharged from the valve-type nozzles to the surface to be printed without any trouble.

The X-Y table 203 includes a mechanism for moving the print head 202 and the camera 204 in the X direction and the Y direction which are perpendicular to each other. Specifically, the X-Y table 203 includes an X-axis movement mechanism 205 and a Y-axis movement mechanism 206. The X-axis movement mechanism 205 moves a slider which holds the print head 202 and the camera 204 to be described below in the X direction. The Y-axis movement mechanism 206 moves the X-axis movement mechanism 205 in the Y direction while holding the X-axis movement mechanism 205 with two arms. The Y-axis movement mechanism 206 includes a shaft 207. The shaft 207 is held and driven by a robot arm 208. By so doing, the print head 202 can be freely arranged at a predetermined position at which printing is performed on the object to be printed M. For example, when the object to be printed M is an automobile, the robot arm 208 can arrange the print head 202 at an upper position of the automobile as illustrated in FIG. 14 or at a lateral position of the automobile as illustrated in FIG. 15. Operation of the robot arm 208 is controlled based on a program stored in the controller 209 in advance.

The camera 204 is an imaging unit such as a digital camera that captures an image of the surface to be printed of the object to be printed M. The camera 204 captures an image of a predetermined range of the surface to be printed of the object to be printed M at a constant minute interval while moving in the X direction and the Y direction by the X-axis movement mechanism 205 and the Y-axis movement mechanism 206, respectively. The specifications of, for example, the lens and resolution of the camera 204 are selected as appropriate such that multiple subdivided images can be captured for the predetermined range of the surface to be printed. The capturing of the multiple subdivided images of the surface to be printed by the camera 204 is continuously and automatically performed by the controller 209 to be described below.

The controller 209 causes the X-Y table 203 to operate based on image editing software S for editing images captured by the camera 204 and a preset control program to control the printing operation, i.e., ink discharge operation, of the print head 202. The controller 209 includes a so-called microcomputer. The controller 209 includes, for example, a storage device, a central processing unit (CPU), input devices such as a keyboard and a mouse, and a digital versatile disc (DVD) player as needed. The storage device records and stores various programs, captured images, and images to be printed. The CPU executes various processing in accordance with the programs. The controller 209 further includes a monitor 210. The monitor 210 displays, for example, input data to the controller 209, processing results by the controller 209.

The controller 209 performs image processing on multiple pieces of subdivided image data captured by the camera 204 using image processing software. By so doing, the controller 209 converts the surface to be printed of the object to be printed M, which is not a flat surface, to a composite print surface to be projected onto a flat surface. In addition, the controller 209 superimposes an image to be drawn with an image already printed on the surface to be printed continuously on the composite print surface. Then, the controller 209 performs editing such that the image to be drawn continues with an edge of the image which has already been printed, to generate an edited image to be drawn. For example, the controller 209 edits a print image 252b, which is an image to be drawn illustrated in FIG. 16C, such that the print image 252b matches a print image 252a on a composite print surface and a non-print region 253 is not formed between the print image 252b and the adjacent print image 252a. By so doing, the controller 209 generates an edited image to be drawn. Subsequently, ink is discharged from the print head 202 onto a surface to be printed based on the generated edited image to be drawn. By so doing, a new image is printed without a gap between the new image and the image that has been printed. The operation of capturing the multiple subdivided images by the camera 204 and the operation of printing by discharging ink from each nozzle of the print head 202 are performed by the driver 211 whose operation is controlled by the controller 209.

In FIG. 16A, arrows are illustrated to indicate a direction in which ink is discharged from each of the inkjet nozzles mounted on a nozzle head 250, when a two-dimensional rectangle is formed by the ink discharged from the inkjet nozzles on a spherical surface of a liquid application object 251 which is a spherical object. In FIG. 16B, ink discharged from the inkjet nozzles mounted on the nozzle head 250 is discharged in a direction perpendicular to the nozzle head 250. Accordingly, the print image 252a that is printed on the liquid application object 251 is illustrated as a rectangle with distorted edges.

### Electrode Manufacturing Apparatus

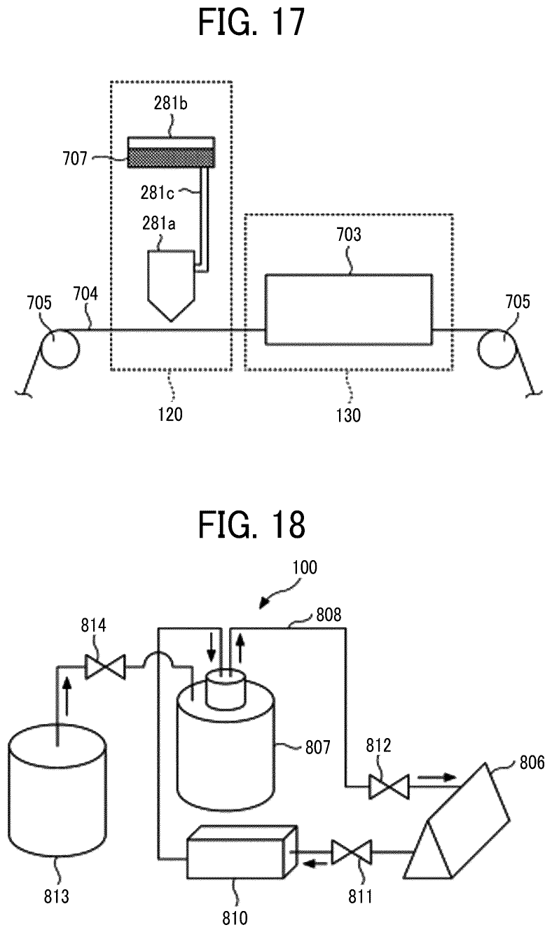

Embodiments of the present disclosure can also be applied to electrode manufacturing apparatuses and electrochemical element manufacturing apparatuses. An electrode manufacturing apparatus according to an embodiment of the present disclosure is described below. FIG. 17 is a schematic diagram illustrating an electrode manufacturing apparatus to manufacture electrodes in an electrode manufacturing method, according to the present embodiment. The electrode manufacturing apparatus discharges liquid composition using the above-described liquid discharge apparatus 100 to manufacture electrodes including layers containing an electrode material.

### Device for Forming Layer Containing Electrode Material and Process of Forming Layer Containing Electrode Material

The above-described liquid discharge apparatus 100 serves as a discharger of the present embodiment to discharge the above-described liquid. The liquid discharge apparatus 100 discharges liquid composition to apply the liquid composition onto an object to form a liquid composition layer. The above-described object, which may also be referred to simply as a discharge object in the following description, is not particularly limited and may be appropriately selected depending on the intended purpose, as long as a layer containing the electrode material can be formed on the object. Examples of the object include an electrode circuit board, i.e., a current collector, an active material layer, and a layer containing a solid electrode material. The discharger and the discharging process may have a configuration in which the liquid composition is directly discharged to form a layer containing the electrode material or a configuration in which the liquid composition is indirectly discharged to form a layer containing the electrode material, as long as the layer containing the electrode material can be formed on the discharge object.

### Other Configurations and Other Processes

Other configurations of the apparatus for manufacturing the electrode mixture layer are not particularly limited and may be appropriately selected depending on the intended purpose, as long as the effects of embodiments of the present disclosure are not impaired. Examples of the other configurations include a heater. Other processes that are included in the method for manufacturing the electrode mixture layer are not particularly limited and may be appropriately selected depending on the intended purpose, as long as the effects of embodiments of the present disclosure are not impaired. Examples of the other processes include a heating process.

### Heater and Heating Process

The above-described heaters 12 serves as heaters to heat the liquid composition discharged by the above-described discharger, i.e., the liquid discharge apparatus 100. Heating process is a process of heating the liquid composition discharged in the above-described discharging process. The liquid composition layer can be dried in the heating process.

Electrode Manufacturing Apparatus that Directly Discharges Liquid Composition to Form Layer Containing Electrode Material

A description is given of an electrode manufacturing apparatus that forms an electrode mixture layer containing an active material on an electrode substrate, i.e., a current collector, below. The electrode manufacturing apparatus includes a discharge process unit 120 and a heating process unit 130. The discharge process unit 120 performs a process of applying a liquid composition onto a printing base material 704 including a discharge object to form a liquid composition layer. The heating process unit 130 performs a heating process of heating the liquid composition layer to obtain an electrode mixture layer. The electrode manufacturing apparatus includes a conveyor 705 to convey the printing base material 704. The conveyor 705 conveys the printing base material 704 via the discharge process unit 120 and the heating process unit 130 sequentially in this order at a preset speed. The method for manufacturing the printing base material 704 including a discharge object such as the active material layer is not particularly limited, and a known method can be appropriately selected. The discharge process unit 120 includes a printer 281a to perform an application process of applying a liquid composition 707 onto the printing base material 704, a storage container 281b to store the liquid composition 707, and a supply tube 281c to supply the liquid composition 707 stored in the storage container 281b to the printer 281a.

The storage container 281b stores the liquid composition 707. The discharge process unit 120 discharges the liquid composition 707 from the printer 281a and applies the liquid composition 707 onto the printing base material 704. Thus, the discharge process unit 120 forms a liquid composition layer in a thin film shape on the printing base material 704. The storage container 281b may be integrated with an apparatus for manufacturing the electrode-mixture layer or may be detachable from the apparatus for manufacturing the electrode-mixture layer. The storage container 281b may be a container additionally attachable to a container integrated with the apparatus for manufacturing the electrode-mixture layer or a container detachable from the apparatus for manufacturing the electrode mixture layer.

The storage container 281b and the supply tube 281c can be selected as desired as long as the liquid composition 707 can be stably stored and supplied.

As illustrated in FIG. 17, the heating process unit 130 includes a heating device 703. The heating process unit 130 performs a solvent removal process in which residual solvent in the liquid composition layer is heated, dried, and removed by the heating device 703. As described above, the electrode mixture layer can be formed. The heating process unit 130 may perform the solvent removal process under reduced pressure.

The heating device 703 is not particularly limited and may be appropriately selected depending on the intended purpose. Examples of the heating device 703 include, for example, a circuit board heater, an infrared (IR) heater, and a hot air heater. A circuit board heater, an IR heater, and a hot air heater may be combined to serve as the heating device 703. Heating temperature and heating time can be appropriately selected in accordance with the boiling point of the solvent contained in the liquid composition 707 and the thickness of the liquid composition layer to be formed.

FIG. 18 is a schematic diagram illustrating an electrode manufacturing apparatus, i.e., the liquid discharge apparatus 100, according to an embodiment different from the above-described embodiments of the present disclosure. The liquid discharge apparatus 100 controls a pump 810, and control valves 811 and 812. By so doing, a liquid composition can be circulated through the liquid discharge head 10, a tank 807, and a tube 808. The liquid discharge apparatus 100 includes an external tank 813. When the liquid composition in the tank 807 is reduced, the pump 810 and the control valves 811, 812, and a control valve 814 are controlled such that the liquid composition can be supplied from the external tank 813 to the tank 807. When the electrode manufacturing apparatus according to the present embodiment is employed, the liquid composition can be discharged to intended positions of the discharge object. The above-described electrode mixture layer may be suitably employed as, for example, a portion of an electrochemical element. Components of the electrochemical element other than the electrode mixture layer is not particularly limited, and known components can be appropriately selected. Examples of the components of the electrochemical device include a positive electrode, a negative electrode, and a separator.

The above-descried configurations are examples, and following aspects of the present disclosure have, for example, advantageous effects described below.

### First Aspect

A liquid discharge head such as the liquid discharge head 10, includes a nozzle plate, a needle valve such as the on-off valve 31, a mover such as the piezoelectric element containers 330, 330L, and 330S, a housing such as the housings 11a and the array housing 110, a liquid chamber such as the channel 17, and a sealing member such as the sealing member 34, 34a, 34b, and 34L. The nozzle plate has a nozzle such as the nozzles 14 and 14L from which a liquid such as ink such as the ink 170 is dischargeable in a discharge direction. The needle valve includes a first part having a first diameter and a second part having a second diameter smaller than the first part. The second part has a leading end contactable with the nozzle to close the nozzle. The needle valve is movable in the discharge direction between a separation position at which the needle valve is separated from the nozzle to open the nozzle and a contact position at which the leading end of the second part of the needle valve contacts the nozzle to close the nozzle. The mover moves the needle valve in the discharge direction. The housing has a side wall extending in the discharge direction and a bottom wall perpendicular to the side wall. The side wall and the bottom wall define a container containing the mover inside the housing. The liquid chamber communicates with the nozzle. The sealing member is disposed between the first part of the needle valve and the bottom wall of the housing in the discharge direction to seal the container from the liquid chamber. The sealing member is deformable in the discharge direction in accordance with the movement of the needle valve.

### Second Aspect

In the liquid discharge head according to the first aspect, the second part of the needle valve includes a first side face facing the sealing member in a transverse direction perpendicular to the discharge direction. The side wall of the housing includes a second side face facing the sealing member in the transverse direction. The sealing member is separated from the first facing surface by a first gap in the transverse direction. The sealing member is separated from the second facing surface by a second gap in the transverse direction.

### Third Aspect

In the liquid discharge head according to the first and the second aspect, the needle valve compresses the sealing member to the bottom wall of the housing in the discharge direction to seal the nozzle.

### Fourth Aspect

In the liquid discharge head according to any one of the first to third aspects, the sealing member contacts a first holding portion facing the sealing member in the transverse direction perpendicular to the discharge direction of the needle valve and a second holding portion facing a wall of the liquid chamber in the direction perpendicular to the discharge direction of the needle valve.

### Fifth Aspect

In the liquid discharge head according to the fourth aspect, a portion at which the sealing member and the needle valve contact each other is closer to the nozzle than a portion at which the sealing member and the housing contact each other.

### Sixth Aspect

In the liquid discharge head according to the fifth aspect, the sealing member is disposed to bias the needle valve toward the nozzle.

### Seventh Aspect

In the liquid discharge head according to the first aspect, the sealing member has a tubular shape to connect the first part of the needle valve and the bottom wall of the housing. The needle valve has a first shape in which the needle valve contacts an inner peripheral surface of the sealing member to seal a portion between the container and the liquid chamber in a radial direction of the needle valve. The housing has a second shape in which the housing contacts an inner peripheral surface of the sealing member in the radial direction of the sealing member to seal a portion between the container and the liquid chamber.

### Eighth Aspect

In the liquid discharge head according to any one of the first to seventh aspects, a portion at which the sealing member and the needle valve contact each other is closer to the nozzle than a portion at which the sealing member and the housing contact each other.

### Ninth Aspect

In the liquid discharge head according to the eighth aspect, the sealing member includes an expansion and contraction portion expandable and contractable in the discharge direction.

### Tenth Aspect

A liquid discharge apparatus includes the liquid discharge head and a support supporting the liquid discharge head.

### Eleventh Aspect

A liquid discharge head such as the liquid discharge head 10, includes a nozzle plate, a needle valve such as the on-off valve 31, a mover such as the piezoelectric element containers 330, 330L, and 330S, a housing such as the housings 11a and the array housing 110, a liquid chamber such as the channel 17, and a sealing member such as the sealing member 34, 34a, 34b, and 34L. The nozzle plate has a nozzle such as the nozzles 14 and 14L from which a liquid such as ink such as the ink 170 is dischargeable in a discharge direction. The needle valve includes a first part having a first diameter and a second part having a second diameter smaller than the first part. The second part has a leading end contactable with the nozzle to close the nozzle. The needle valve is movable in the discharge direction between a separation position at which the needle valve is separated from the nozzle to open the nozzle and a contact position at which the leading end of the second part of the needle valve contacts the nozzle to close the nozzle. The mover moves the needle valve in the discharge direction. The housing has a side wall extending in the discharge direction and a bottom wall perpendicular to the side wall. The side wall and the bottom wall define a container containing the mover inside the housing. The liquid chamber communicates with the nozzle. The sealing member is disposed between the first part of the needle valve and the bottom wall of the housing in the discharge direction to seal the container from the liquid chamber. The sealing member is deformable in the discharge direction in accordance with the movement of the needle valve. The needle valve includes a first holding portion such as the sealing-member holding portion 311, 311a, 311b, 311c, and 311L extending in a direction perpendicular to a discharge direction of the needle valve to hold the sealing member. The portion of the wall of the liquid chamber serves as a second holding portion such as the sealing-member holding wall portion 320, 320a, 320b, 320c, and 320L extending in the direction perpendicular to the discharge direction of the needle valve to hold the sealing member. The first holding portion and the second holding portion are positioned to partially overlap each other when viewed from the discharge direction of the needle valve.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A liquid discharge head comprising:
a nozzle plate having a nozzle from which a liquid is dischargeable in a discharge direction;
a needle valve including:
a first part having a first diameter; and
a second part having a second diameter smaller than the first part, the second part having a leading end contactable with the nozzle to close the nozzle,
the needle valve movable in the discharge direction between:
a separation position at which the needle valve is separated from the nozzle to open the nozzle; and
a contact position at which the leading end of the second part of the needle valve contacts the nozzle to close the nozzle;
a mover to move the needle valve in the discharge direction;
a housing having:
a side wall extending in the discharge direction;
a bottom wall perpendicular to the side wall, the side wall and the bottom wall defining a container containing the mover inside the housing; and
a liquid chamber communicating with the nozzle; and
a sealing member disposed between the first part of the needle valve and the bottom wall of the housing in the discharge direction to seal the container from the liquid chamber, the sealing member deformable in the discharge direction in accordance with a movement of the needle valve.

2. The liquid discharge head according to claim 1,
wherein the second part of the needle valve includes a first side face facing the sealing member in a transverse direction perpendicular to the discharge direction,
the side wall of the housing includes a second side face facing the sealing member in the transverse direction,
the sealing member is separated from the first side face by a first gap in the transverse direction, and
the sealing member is separated from the second side face by a second gap in the transverse direction.

3. The liquid discharge head according to claim 1,
wherein the needle valve compresses the sealing member to the bottom wall of the housing in the discharge direction to seal the nozzle.

4. The liquid discharge head according to claim 3,
wherein the first part of the needle valve has a first contact face to contact one face of the sealing member,
the bottom wall of the housing has a second contact face to contact another face opposite to the one face of the sealing member, and
the sealing member is contactable with the first contact face of the needle valve and the second contact face of the bottom wall of the housing at a same time.

5. The liquid discharge head according to claim 4,
wherein a portion at which the sealing member and the needle valve contact each other is closer to the nozzle than a portion at which the sealing member and the housing contact each other.

6. The liquid discharge head according to claim 5,
wherein the sealing member is disposed to bias the needle valve toward the nozzle.

7. The liquid discharge head according to claim 1,
wherein the bottom wall of the housing has a vertical wall extending from the bottom wall in the discharge direction, and
the sealing member has a tubular shape to connect the first part of the needle valve and the vertical wall of the bottom wall in the discharge direction,
the needle valve contacts an inner peripheral surface of the sealing member in a radial direction of the needle valve to seal a portion between the container and the liquid chamber, and
the vertical wall contacts the inner peripheral surface of the sealing member in the radial direction to seal the portion between the container and the liquid chamber.

8. The liquid discharge head according to claim 7,
wherein a portion at which the sealing member and the needle valve contact each other is closer to the nozzle than a portion at which the sealing member and the housing contact each other.

9. The liquid discharge head according to claim 7,
wherein the sealing member includes an expansion and contraction portion expandable and contractable in the discharge direction.

10. A liquid discharge head comprising:
a nozzle plate having a nozzle from which a liquid is dischargeable in a discharge direction;
a needle valve including:
a first part having a first diameter; and
a second part having a second diameter smaller than the first part, the second part extending in a direction perpendicular to the discharge direction and having a leading end contactable with the nozzle to close the nozzle,
the needle valve movable in the discharge direction between:
a separation position at which the needle valve is separated from the nozzle to open the nozzle; and
a contact position at which the leading end of the second part of the needle valve contacts the nozzle to close the nozzle;
a mover to move the needle valve in the discharge direction;
a housing having:
a container containing the mover inside the housing; and
a liquid chamber communicating with the nozzle, the liquid chamber having a liquid chamber wall face extending perpendicular to the discharge direction; and
a sealing member disposed between the first part of the needle valve and the liquid chamber wall face to seal the container from the liquid chamber, the sealing member deformable in the discharge direction in accordance with a movement of the needle valve.

11. The liquid discharge head according to claim 10,
wherein the sealing member contacts a first holding portion of the second part facing the sealing member in the direction perpendicular to the discharge direction and a second holding portion on the liquid chamber wall face in the direction perpendicular to the discharge direction.

12. The liquid discharge head according to claim 10,
wherein a portion at which the sealing member and the needle valve contact each other is closer to the nozzle than a portion at which the sealing member and the liquid chamber wall face contact each other.

13. The liquid discharge head according to claim 10,
wherein the sealing member is disposed to bias the needle valve toward the nozzle.

14. The liquid discharge head according to claim 10,
wherein the sealing member has a tubular shape to connect the first part of the needle valve and a vertical wall portion extending from the liquid chamber wall face along to the discharge direction,
the needle valve contacts an inner peripheral surface of the sealing member to seal a portion between the container and the liquid chamber in a radial direction of the needle valve, and
the vertical wall portion contacts an inner peripheral surface of the sealing member in the radial direction of the sealing member to seal a portion between the container and the liquid chamber.

15. The liquid discharge head according to claim 14,
wherein a portion at which the sealing member and the needle valve contact each other is closer to the nozzle than a portion at which the sealing member and the liquid chamber wall face contact each other.

16. The liquid discharge head according to claim 15,
wherein the sealing member includes an expansion and contraction portion expandable and contractable in the discharge direction.

17. A liquid discharge apparatus comprising:
the liquid discharge head according to claim 10; and
a support supporting the liquid discharge head.

18. A liquid discharge head comprising:
a nozzle plate having a nozzle from which a liquid is dischargeable in a discharge direction;
a needle valve including:
a first part having a first diameter; and
a second part having a second diameter smaller than the first part, the second part having a leading end contactable with the nozzle to close the nozzle,
the needle valve movable in the discharge direction between:
a separation position at which the needle valve is separated from the nozzle to open the nozzle; and
a contact position at which the leading end of the second part of the needle valve contacts the nozzle to close the nozzle;
a mover to move the needle valve in the discharge direction;
a housing having:
a side wall extending in the discharge direction;
a liquid chamber communicating with the nozzle; and
a sealing member disposed between the first part of the needle valve and a bottom wall of the housing in the discharge direction to seal a container from the liquid chamber, the sealing member deformable in the discharge direction in accordance with a movement of the needle valve,
wherein the needle valve includes a first holding portion extending in a direction perpendicular to the discharge direction to hold the sealing member,
a portion of the bottom wall defining a second holding portion extending in the direction perpendicular to the discharge direction to hold the sealing member, and
the first holding portion and the second holding portion are positioned to partially overlap each other when viewed from the discharge direction.
